(19) United States
(12) Patent Application Publication
(10) Pub. No.: US 2007/0291727 A1
(43) Pub. Date: Dec. 20, 2007

(54) High Availability System Based on Separated Control and Traffic System

(75) Inventors: Pal Longva Hellum, Sandvika (NO); Per Erik Moldskred Nissen, Drammen (NO); Reidar Schumann-Olsen, Lier (NO)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 10/595,136

(22) PCT Filed: Sep. 2, 2004
(86) PCT No.: PCT/NO04/00260

§ 371 Date: Aug. 6, 2007

(30) Foreign Application Priority Data
Sep. 3, 2003 (NO) 20033897

(51) Int. Cl. H04J 3/02; G08B 17/00; H04L 12/24

(52) U.S. Cl. 370/345; 340/584; 370/241.1

(57) ABSTRACT

The present invention discloses a System comprising a number of plug-in units, where each of the plug-in units that is hosting a device processor is comprising two flash memory banks, and further a traffic and a control system that are separated within said node and/or each of said plug-in units have separate traffic and control system. The present invention further discloses a method for non interruptible installation, operation, maintenance, supervising and hardware or software upgrading the telecom or data communication node.

### FIELD OF THE INVENTION

The invention relates to High Reliability systems for Real Time Traffic, and more particularly to a communication node and a method relating thereto.

### BACKGROUND OF THE INVENTION

The last years have seen a revolution within tele- and data communication, and there are no signs indicating a change to this trend. The communication medium has changed from traditional wired circuit switched networks to packet switched networks using fibres, and combinations thereof. Further, a similar revolution has taken place within network nodes. Hence there is a continuous upgrade of both traffic/network nodes and the wire/fibre network. The ever increasing need for increased bandwidth combined with extremely tough requirements for reliability and security puts a tremendous demand on tele- and datacom equipment manufacturers, both with regard to hardware and software. Upgrading of the tele- and datacom-infrastructure means replacement of hardware and installation of new software. This upgrade should be performed without disturbing the traffic, or at least with a minimal effect on the traffic. Further, components will degrade or become defective with age, due to environmental conditions such as temperature fluctuations, high temperature, humidity fluctuations, high humidity, dust, vibration or other parameters affecting the life span of a product. Within software there is a correlative situation; new services are established, new standards introduced and still continuous service is expected. The long and short of it, is that service and maintenance on the tele- and datacom-infrastructure have to be carried out continuously without disrupting traffic, thus complicated and expensive redundant systems are developed, and further, algorithms for rerouting of traffic must be present. Swapping equipment and replacement of equipment should be possible without having to use too expensive and/or complicated systems, and still the required mean time between failure (MTBF) should be met. Further, as short as possible mean time to repair (MiTR) should be emphasized.

As indicated above, fluctuating temperatures or high temperatures may destroy electronic equipment; hence good cooling of the electronic equipment is essential. Further it is essential to have some kind of “shut down” mechanism to protect the electronics in case of too high temperatures. Traditionally, this hardware shutdown for protection of the hardware will be executed without any warnings, hence loss of availability will be the result without such warnings or notifications.

Today, redundancy is the answer to most of the demands set forth regarding reliability. Still, to have seamless swapping between redundant systems is a most demanding task, either it be hardware or software swapping, either the swapping is intended or caused by equipment or software failure. To replace old equipment or outdated equipment or software with new will often cause dropping of packets, resending of packets, or shorter or longer interruptions on circuit switched lines. Good practices and sophisticated algorithms for rerouting of traffic may solve some of the problems above, still there is a need for a traffic node which will have an outstanding MTBF, a short MiTR, uninterruptible software upgrade, built-in check independent of traffic and hardware upgrade independent of traffic. Thus, the present invention discloses such a system and a method for operating and using such a system.

### SUMMARY OF THE INVENTION

It is an object of the present invention to provide a method avoiding the above described problems.

The features defined in the independent claims enclosed characterize this method.

In particular, the present invention provides a telecommunication or data communication node comprising a number of plug-in units, a first number of the plug-in units is hosting a device processor, the first number of the plug-in units comprises two flash memory banks, where a traffic and a control system are separated within said node and/or each of said plug-in units have separate traffic and control system.

Further it is disclosed a method for non interrupting installation, operation, maintenance, supervising, hardware or software upgrading a telecom or data communication node where the node comprises a plurality of plug-in units a one or more backplane buses, a first number of the plug-in units is hosting a device processor, the first number of the plug-in units comprises two flash memory banks, where hot swapping/removing/replacing a plug-in unit comprises the step of:
a. pushing or pulling a first switch indicating a plug-in unit removal,
b. wait for a first signal indicating an activation of the first switch,
c. when the first signal becomes active, the first signal denotes a start of a board removal interval time, τ₂, and
d. the plug-in unit can be removed during the board removal interval.

### BRIEF DESCRIPTION OF THE DRAWINGS

In order to make the invention more readily understandable, the discussion that follows will refer to the accompanying drawings.

FIG. 1 shows a simple system illustrating the separation principle,

FIG. 2 shows temperature management vs. time/temperature,

FIG. 3 shows a simplified view of the passive and active bank,

FIG. 4 shows the Traffic Node system description,

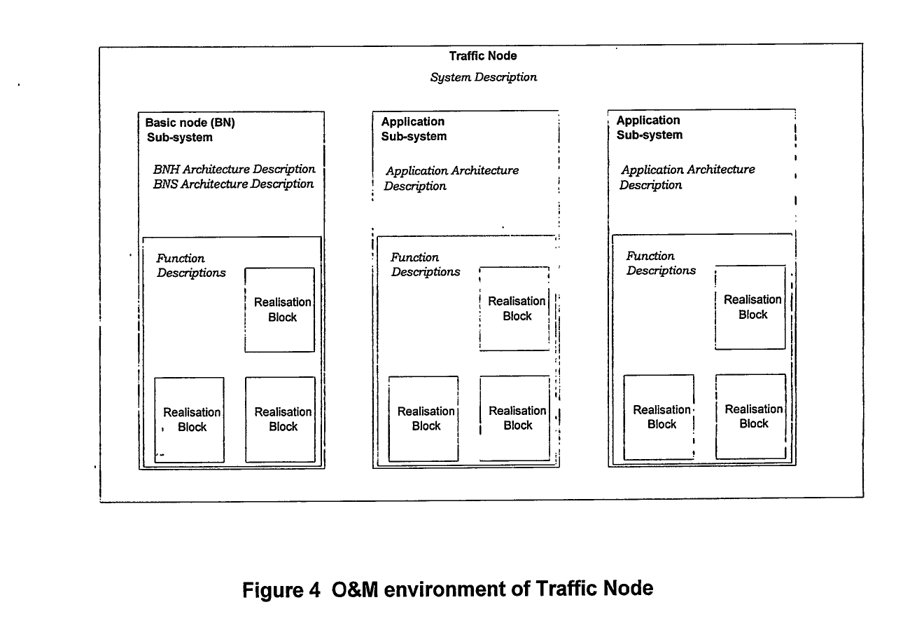

FIG. 5 Application of the TN in the Lower Radio Access Network,

FIG. 6 LRAN network and the role of various TRAFFIC NODE sub-networks,

FIG. 7 O&M environment of Traffic Node,

FIG. 8 The TN IP based DCN,

FIG. 9 TN modularity,

FIG. 10 TN architecture,

FIG. 11 TN software architecture,

FIG. 12 TN BNH buses and building blocks,

FIG. 13 The TN AMM 20p Backplane,

FIG. 14 TN BNS,

FIG. 15 TN EEM: Framework and Basic Node,

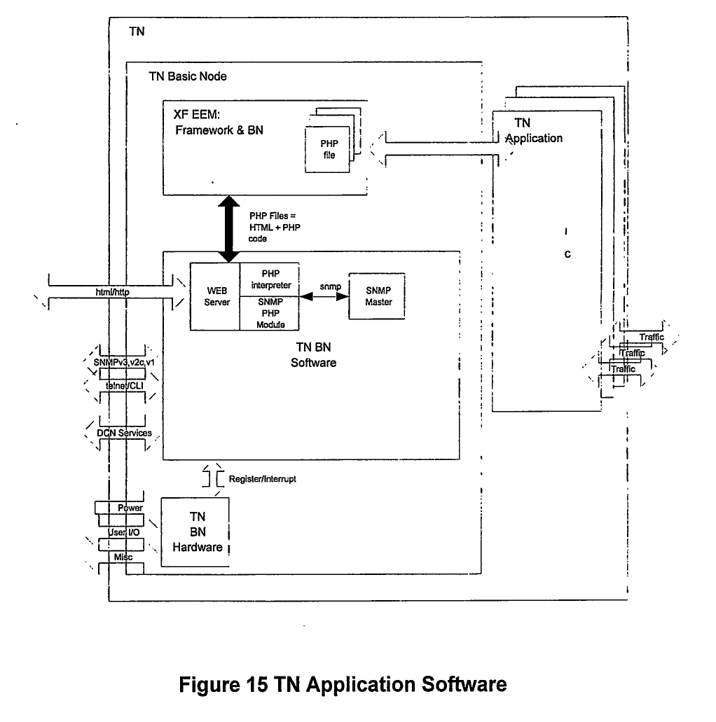

FIG. 16 TN BNH,

FIG. 17 TN Application architecture,

FIG. 18 TN Application Software,

FIG. 19 TN ANS architecture,

FIG. 20 TN Application EEM,

FIG. 21 TN Application Hardware,

FIG. 22 TN APU,

FIG. 23 example of a bi-directional 3*64 Kbs cross-connection between the two APUs,

FIG. 24 PM handling in TN,

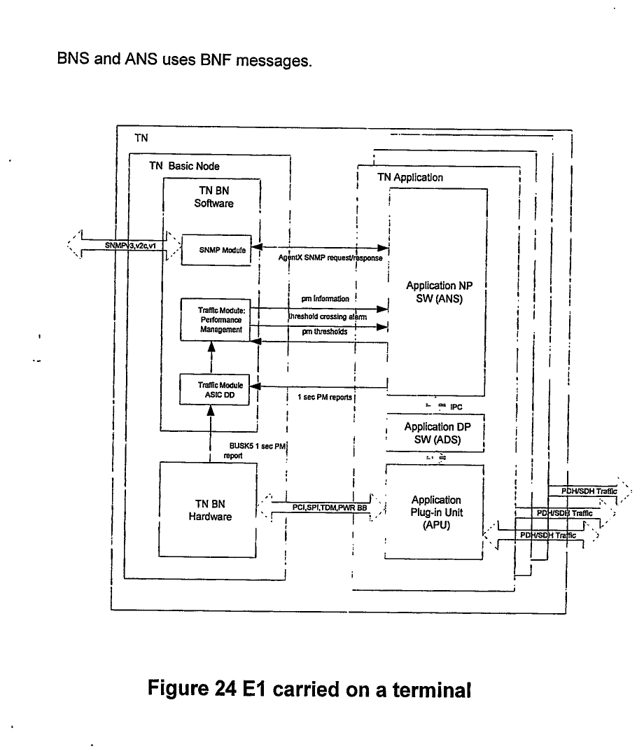

FIG. 25 TN Alarm Handling overview,

FIG. 26 E1 carried on one interface,

FIG. 27 E1 carried on a terminal,

FIG. 28 Redundancy model—basis for calculations,

FIG. 29 PIU function blocks,

FIG. 30 ASIC block structure,

FIG. 31 TDM bus redundancy,

FIG. 32 AMM 20p with redundant power distribution,

FIG. 33 AMM 20p without redundant power distribution,

FIG. 34 AMM 6p BN,

FIG. 35 General model for protected interfaces,

FIG. 36 Simplified model for protected interfaces,

FIG. 37 General model—unprotected interfaces,

FIG. 38 MCR 1+1,

FIG. 39 MCR 1+0,

FIG. 40 MCR terminal 1+1,

FIG. 41 MCR terminal 1+0,

FIG. 42 STM-1 terminal 1+1,

FIG. 43 STM-1 terminal 1+0,

FIG. 44 E1 terminal 1+1,

FIG. 45 E1 terminal 1+0 (SNCP),

FIG. 46 Install new node,

FIG. 47 Repair NPU,

FIG. 48 Change forgotten password,

FIG. 49 Emergency fallback NPU,

FIG. 50 Removal of board (for information only),

FIG. 51 Fault handling of hardware and software error,

FIG. 52 Save command handling,

FIG. 53 TN Handling of node error,

FIG. 54 TN Handling of APU/PIU errors,

FIG. 55 example of TN System Release structure,

FIG. 56 Illustration of the various contents of the APU/NPU memory banks,

FIG. 57 The Software Upgrade process illustrated,

FIG. 58 Su of a single APU due to a APU restart,

FIG. 59 Hot Swap Software Upgrade,

FIG. 60 TN reference network topology.

### DETAILED DESCRIPTION OF THE INVENTION

In the following, the present invention will be discussed first in general, thereafter; a more detailed discussion will be presented where several embodiments of the present inventions are disclosed.

The present invention discloses a versatile highly reliable traffic node with an outstanding availability. Several features of the traffic node will be described separately so as to ease the understanding and readability. The principle behind the software management, the principles behind the temperature control and the principles behind the hardware architecture of the node will be described in separate parts of the description so as to fully point out the advantages of the traffic node according to the present invention.

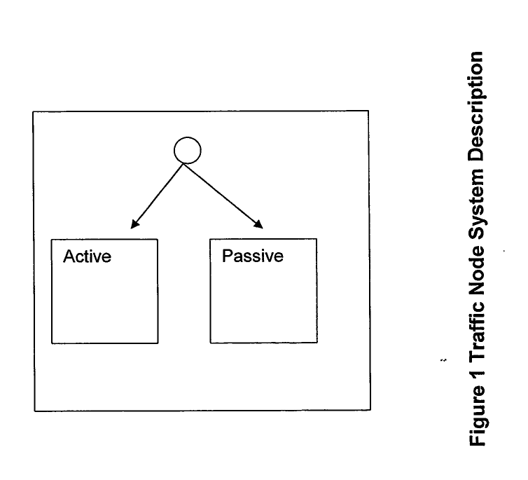

One of the basic ideas behind the invention is to clearly distinguish between traffic and control signals within the node, both on an interboard and on an intraboard basis. Some really advantageous features will be evident due to this separation. A major advantage with the distinct separation between traffic and control is that one will be able to operate traffic independently of the operation of the control part, this is essential for availability, upgrade, temperature control service and maintenance etc. In FIG. 1 is depicted a simple system is depicted illustrating this separation and the advantages caused by this separation.

Temperature Management

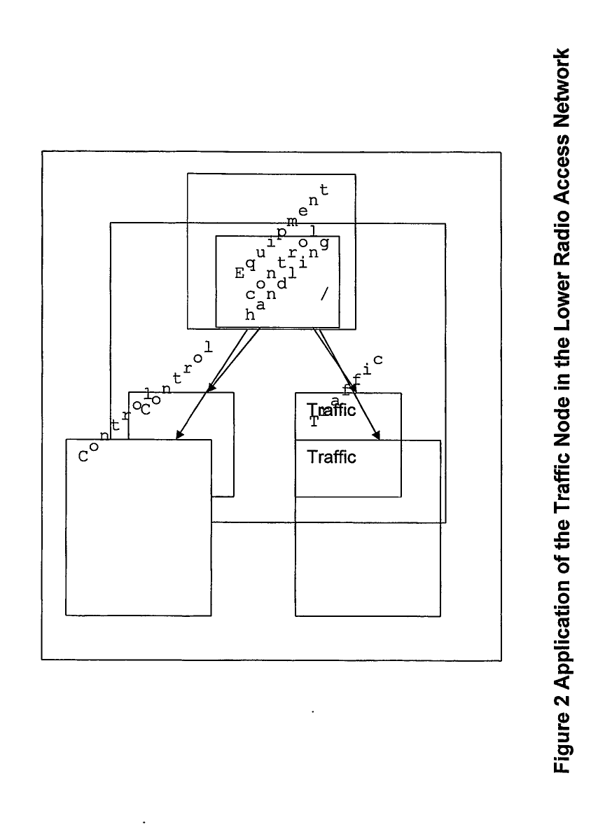

With respect to temperature control, the separation implies that in case of too high temperature one can reduce the power drain consumption by disabling the control part/function. Due to the separation of traffic and control this will not affect the traffic. Further, to improve the temperature management the present invention discloses not only the separation of traffic and control, but also stepwise shutdown of the equipment. With reference to FIG. 2, a two steps' shutdown and recover scenario is depicted, however the principle may be implemented with more than two steps. With reference to the two step shutdown/recover scenario the following cyclic description applies:

If High Temp. threshold (HTT)=1=>control in idle If HTT=1=>send alarm to operation and management system (OAM)

If Excessive temp. threshold (ETT)=1=>hardware shutdown, for protection of hardware against heat damage, alarm is sent to the OAM.

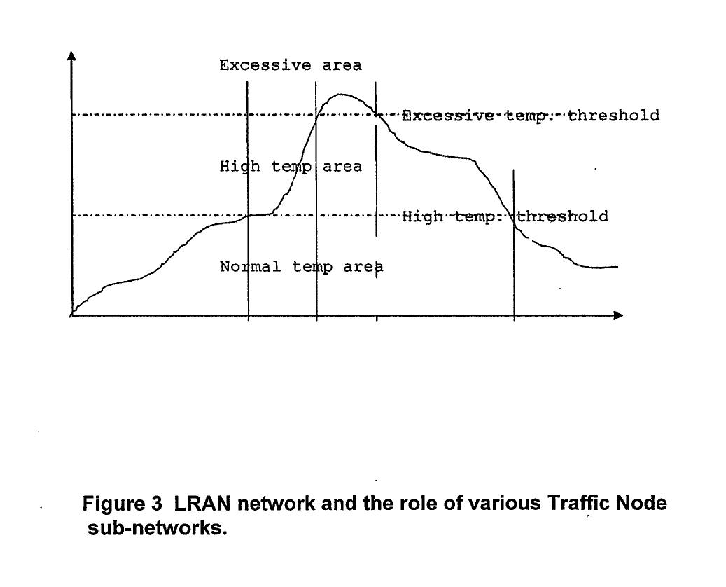

Cyclic description referred to the time axis FIG. 3:

0→1 normal operation,

1→2 the control functions are automatically placed in idle/out of operation without interrupting the traffic alarm sent to OAM,

2→3 automatic hardware shutdown, i.e. traffic and control is set in an out of operation modus, a status alarm is sent to OAM—the system is “sleeping”,

3→4 the system is automatically restarted, however without the control functions in operation, status sent to OAM,

4→ . . . the system is automatically returning to normal operation.

Numerous advantages due to the temperature management system depicted above are evident;
the system may operate at a higher temperature, thus implying an increased capacity, and a reduced fan dependency,
increases the availability of the system due to the separation of control and traffic, as interruption to the control section does not interfere/interrupt the traffic,
generally an improved temperature management is positive with regard to improved life time, service etc.

Further, the temperature management system according to the present invention may use redundant fans, hence making the only single point of failure the controller board for the fans. A more thorough discussion regarding the temperature management system will be given in a subsequent section posterior to the sections describing other features of general character.

The bifurcated architecture described above is to be found on intraboard level as well as on interboard level, further it is to be found within the memory management of the Traffic node according to the present invention.

Software Upgrade—General Principle

In principle, one has two banks, one active and one passive (cf. FIG. 3), where both are operating with software/hardware versions which are tested and proofed, e.g. called version n. Upgrading from version n to n+1 one will download a version n+1 to the passive bank.

Subsequently a test-run will be executed on this new version n+1 if the test-run does not show any sign of fatal failure with the upgrade software, e.g. may cause loss of contact with the program, a pointer is written to the passive bank making the passive bank the active one and consequently the previous active the passive. Thus one will have an active bank operating with the version n+1, and a passive bank operating with version n. Of course, one may reverse the above described process any time.

An algorithm used in case of acceptance of software is briefly discussed in the following and a more detailed discussion is disclosed in a subsequent section.
Question: Acceptance of software?
yes, executing a manual switch, i.e. performing a switchover between active and passive bank manually, and downloading the necessary software
yes, doing an automatic switchover between passive and active bank after test-run, and downloading the necessary software.
   An in Depth Description of a Preferred Embodiment of the Invention

Based on the principles indicated above the Traffic Node's (TN) architecture and functionality will be described in detail in the following sections. The description is a principle/concept description. Accordingly, changes are possible within the scope of the invention.

The Traffic Node and its Environment.

The Microwave Network

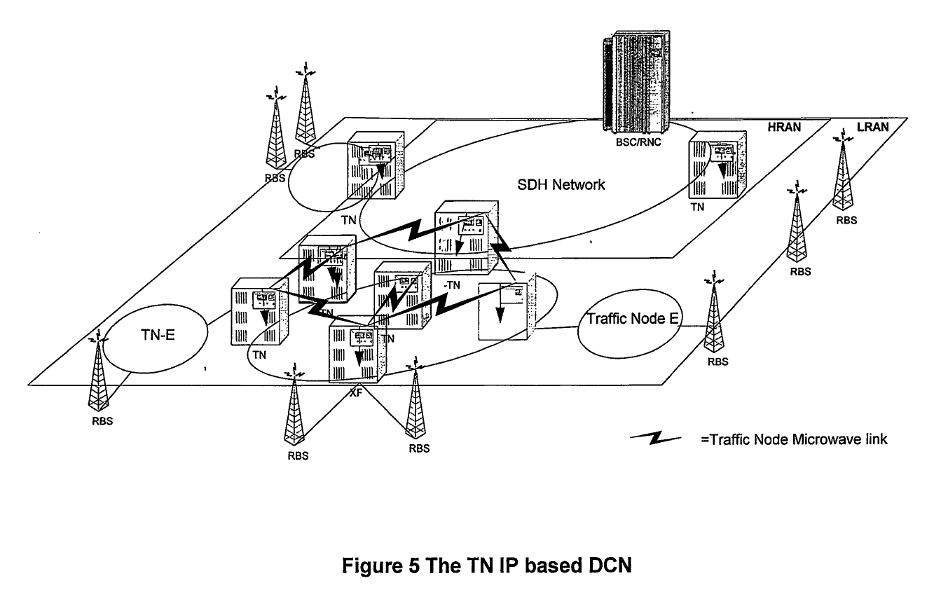

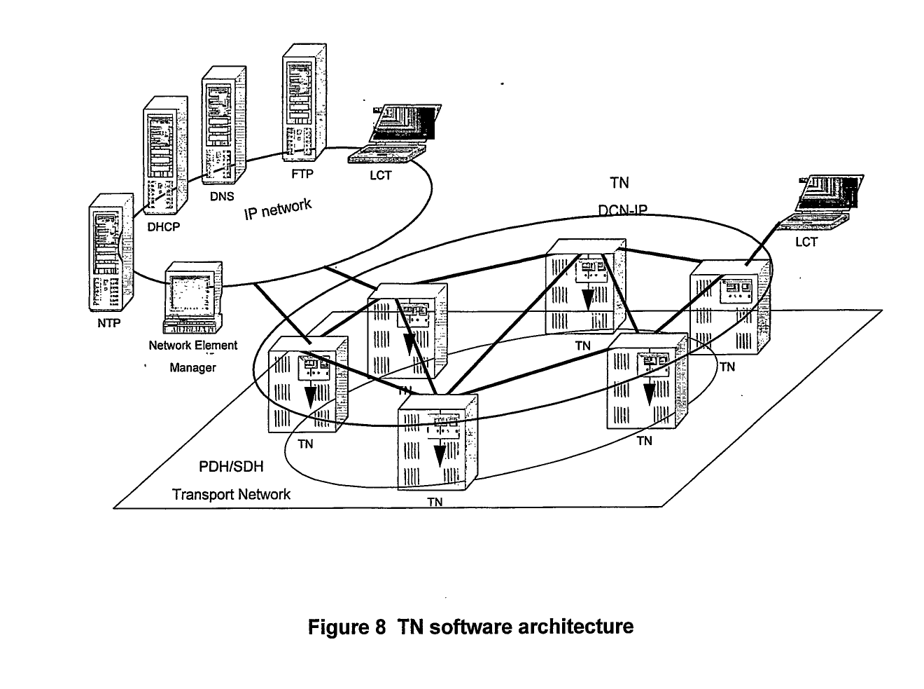

The TN is among others targeted to work in the PDH/SDH microwave transport network for the LRAN 2G and 3G mobile networks, as shown in FIG. 5, however the TN is a versatile node capable of operating both data and telecommunication traffic. It may also operate in IP networks or within Ethernet (cf FIG. 8).

End-to-end connectivity in the TRAFFIC NODE microwave network is based on E1 network connections, i.e. 2 Mbit/s. These E1 network connections are transported over the Traffic Node microwave links. The capacity of these microwave links can be the following:
2 E1, i.e. 2×2 Mbit/s
1×E2, i.e. 1×8 Mbit/s
2×E2, i.e. 2×8 Mbit/s
1×E3+1×E1, i.e. 34 Mbit/s+2 Mbit/s
1×STM-1, i.e. 155 Mbit/s

Connectivity to/from the microwave network is provided through:
G.703 E1 interface
STM-1 interface

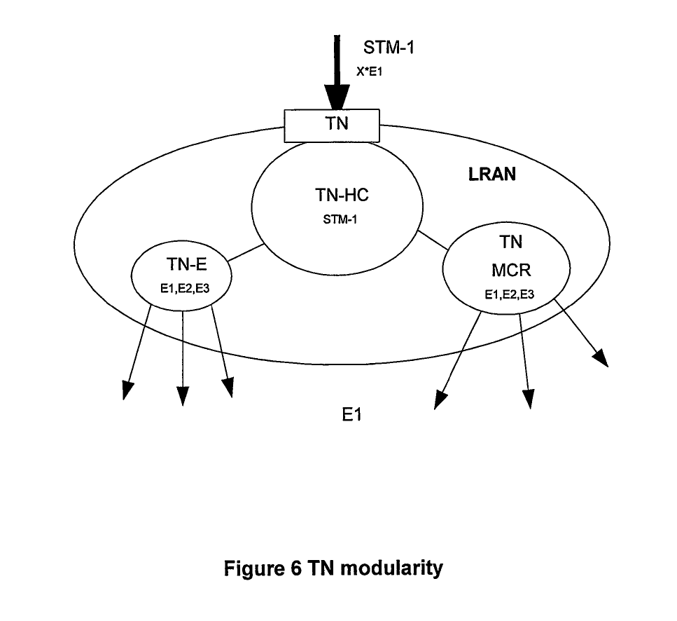

This is illustrated in FIG. 6.

The microwave network consists of the following network elements:

Traffic Node E according to the present invention providing:
Medium Capacity Radio, 2×2-34+2 Mbit/s
PDH access on E1, E2 and E3 levels
Traffic Node High Capacity providing:
High Capacity Radio, 155 Mbit/s
Optical/electrical STM-1 access
Traffic Node comprising:
E1 cross-connect
Generic network interfaces:
PDH access on E1 level
SDH access through optical/electrical STM-1
Traffic Node E compatible Medium Capacity Radio
Traffic Node E co-siting solution

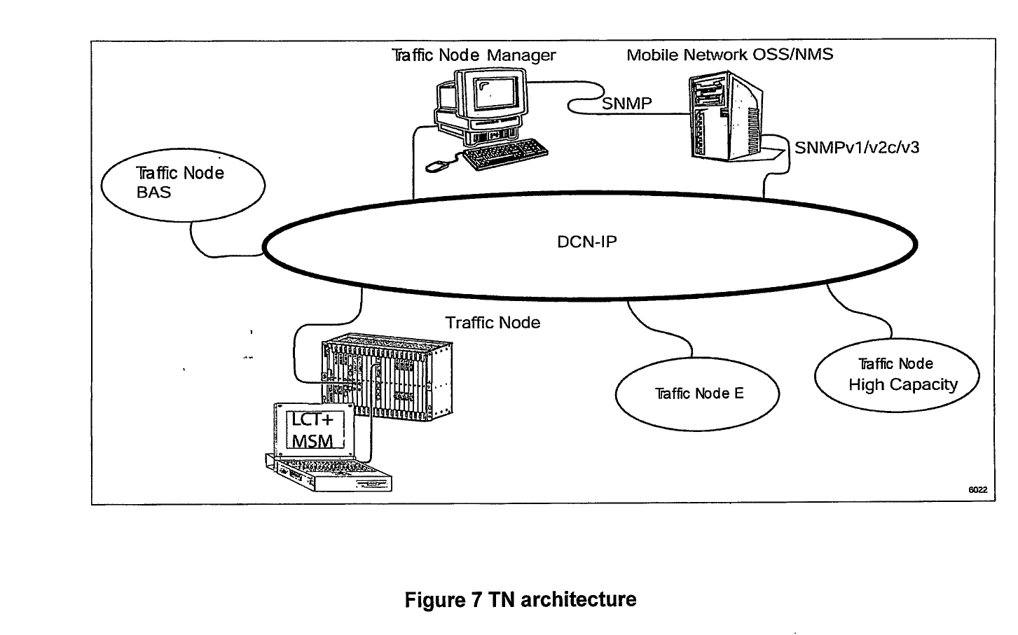

FIG. 7 shows that the Traffic node according to the present invention can be managed by:
A Local Craft Tool (EEM). This is computer with a web browser that connects with the Embedded Element Manager (EEM).
Remotely by Traffic Node Manager, using a combination of both EEM and SNMP interface.
Remotely by an operator specific Operations Support System (OSS) or Network Management System (NMS).
   The DCN-IP Network

In order to perform management of the TNs a Data Communications Network (DCN) is required. This is an IPv4 based DCN that uses in-band capacity on the transport links by means of unnumbered Point to Point Protocol (PPP) links. This requires a minimum of IP network planning and doesn't require configuration of the TN in order to connect to the DCN. OSPF is used as a routing protocol. Together an Ethernet-based site-LAN connection to the TN, the TN DCN can be connected to any existing IP infrastructure as shown in FIG. 8. TN communicates with the following services:
DHCP, for assignment of IP addresses to equipment on the site-LAN, e.g. the EEM. The TN provides DHCP relay functionality for this.

NTP, the TN uses NTP for accurate time keeping
FTP, used for software upgrade and configuration up and download.

The Network Element Manager (NEM) uses SNMP for monitoring and configuring the TN.

The EEM is a PC that communicates HTML pages containing JavaScript over HTTP with the Embedded Element Manager (EEM) in the TN by means of a web browser.

TN Principles.

This section describes the architecture of the TN, which consists of a Basic Node (BN) and Applications, and the principles on which it is based (cf. FIG. 1). Before looking at the architecture in it self, the principles of the basis for the architecture design are described below.

Modularity.

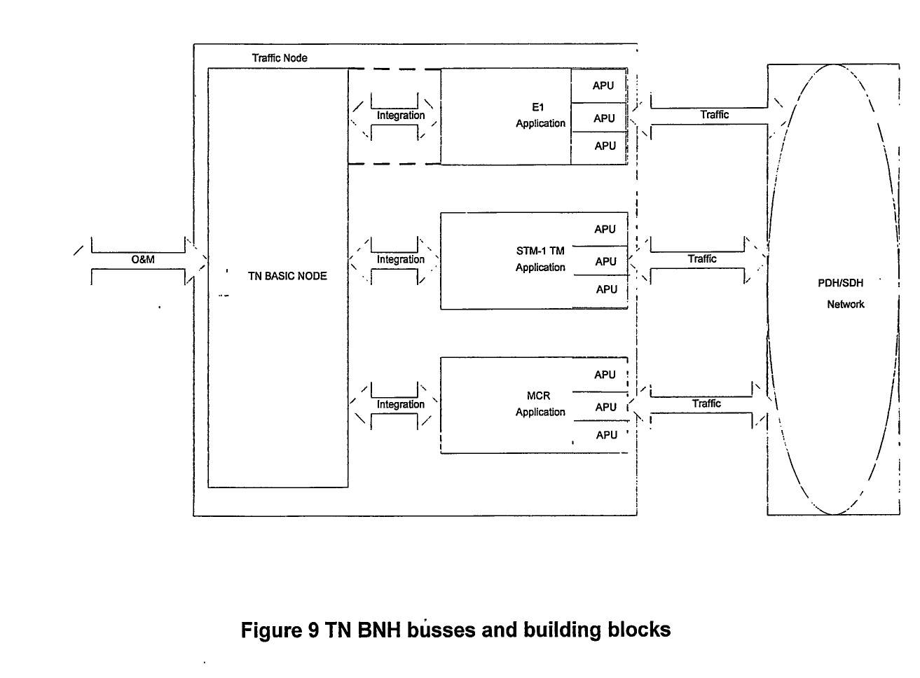

The TN is based on a modular principle where HW and SW application can be added to the system through the use of uniform mechanisms refer to FIG. 9.

This allows for a flexible upgrade from both a HW and SW perspective, hence, new functionality can be added with minimal effort.

The TN Basic Node (TN BN) provides re-usable HW and SW components and services for use by application designers.

Software of the TN BN and various applications, like MCR and STM-1, are integrated by the well defined interfaces. These interfaces are software function calls, file structures, hardware buses or common hardware and software building blocks. The well defined interfaces enable the application flexibility in design. As long as they conform to the interfaces there is a high level of freedom in how both software and hardware are implemented.

Scalability

The principle of modularity and distribution of the system through the buses and their building blocks makes the system linearly scalable.

The distributed switching hardware architecture allows for the size of the node to scale from large node (20 APUs) down to small nodes (1 or 2 APUs).

The alternative centralised switching architecture allows for scaling up to higher capacity where the distributed architecture doesn't allow for capacity increase.

Offering both a distributed switching architecture as well as being prepared for a centralised switching architecture enables scalability of traffic rates required today and in the future.

Functional scalability is achieved through a distributed software architecture which allows for new functionality (applications) to be added trough well defined interfaces.

Separated Control and Traffic Systems

A principle used to improve robustness is to separate the control and traffic system of the TN. The control system configures and monitors the traffic system whilst the traffic system routes the traffic through the TN. Failure and restarts of the control system will not influence the traffic system.

Separation of control and traffic system applies throughout the node and its PIUs.

This enables e.g. software upgrade of the TN without disturbing traffic. In the architecture description later it will be pointed out whether a component is part of the control or the traffic system.

Redundancy

A principle that provides robustness to the TN is “no single point of failure” in the traffic system. This means that the traffic is not disturbed as long as one failure occurs in the system. This is realised by redundant traffic buses, optional redundant power and traffic protection mechanisms. More details on the redundancy of the various system components can be found in the following architecture sections.

The architecture allows, for application to implement redundancy, like MSP 1+1 for the STM1- application or 1+1 protection for the MCR link.

In Service Upgrade

The principle of in-service upgrade, i.e. upgrade without disturbance of traffic, of both software and hardware functionality in the Traffic Node is applicable for:
Upgrade of all software in the Traffic Node to a new System Release
Hot-insertion of PIUs that are automatically upgraded to software matching the existing System Release of the Traffic Node.

Hot-swap of PIUs where a new PIU inherits the configuration of the old PIU.

APU Handled by One Application

Every APU in the traffic node are handled by one application. One application can, however, handle several APUs, even of a different type.

Functional Distribution Basic Node Versus Applications

Some basic principles have been established in the traffic node according to the present invention when it comes to functional distribution between a common Basic Node and Applications. In this model applications are concerned with the providing of physical bearers for end-to-end connections, i.e. physical and server layer links for PDH traffic. This entails:
Line interfaces
Server layer multiplexing (everything “below” PDH)
Fault propagation (on link level)
Physical line protection
Physical line diagnostics like loops and BERT
Peripheral equipment handling, e.g. RAU.

Whereas Basic Node provides:
Generic/standard network interfaces
PDH Networking
PDH multiplexing
Fault Propagation (network level)
Cross-connection
Network protection, i.e. SNCP
Network layer diagnostics like loops and BERT
DCN handling, i.e. IP and its services like routing, FTP etc.

Equipment Handling on node and PIU levels
Maintaining consistent configuration of the node, e.g. a System Release.

Means to an application to communicate with /control its APUs.

TN Architecture

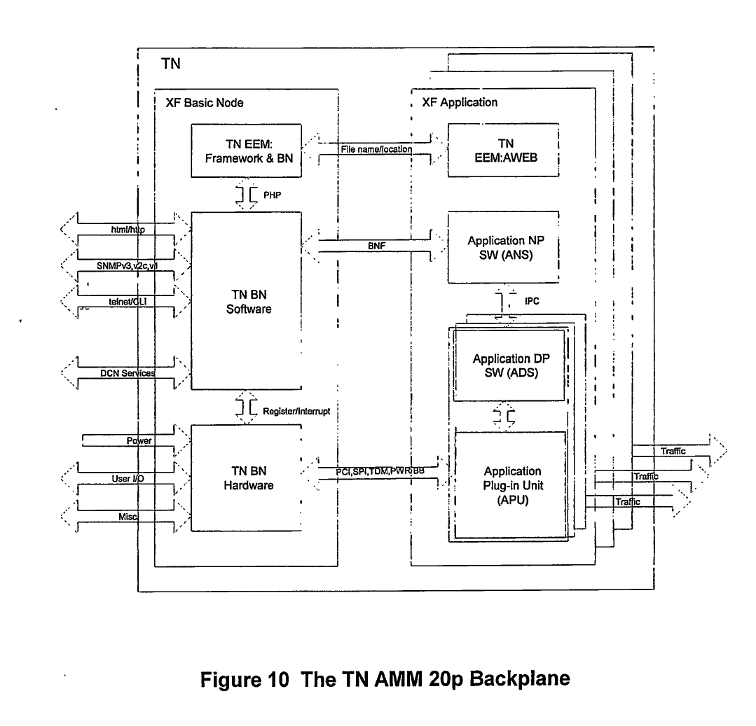

FIG. 10 shows a complete overview of the TN architecture. In a TN there will be one component called TN BN and several different instances of the TN Application component. Both kind of components can consist of both hardware and software.

The next sections will first look at the overall software and hardware architecture of the TN. Afterwards the basic node architecture and application architecture will be described more detailed.

TN Software Architecture

The TN software consists of three major software component types:
Basic Node Software (BNS)
Application Node processor Software (ANS
Application Device Processor Software (ADS).

As shown in FIG. 10, TN BNS and the various applications communicate through the Basic Node Functions (BNF) interface. This interface consists of two protocols:
AgentX that together with its SNMP master and SNMP sub-agents acts as an object request broker used for realising an extensible SNMP agent. The SNMP sub-agents subscribe with the SNMP-master in the BNS to receive the SNMP requests that the applications wants to handle. The SNMP master in its turn acts as a post-master that routes SNMP requests to the SNMP sub-agents in the applications.
CLI based on the same principles as AgentX, but then for the CLI protocol. This interface is used for CLI requests, collection of configuration data for persistent storage and configuration at start-up.
Basic Node Functions (BNF) signals, a proprietary message interface for inter-process communication.

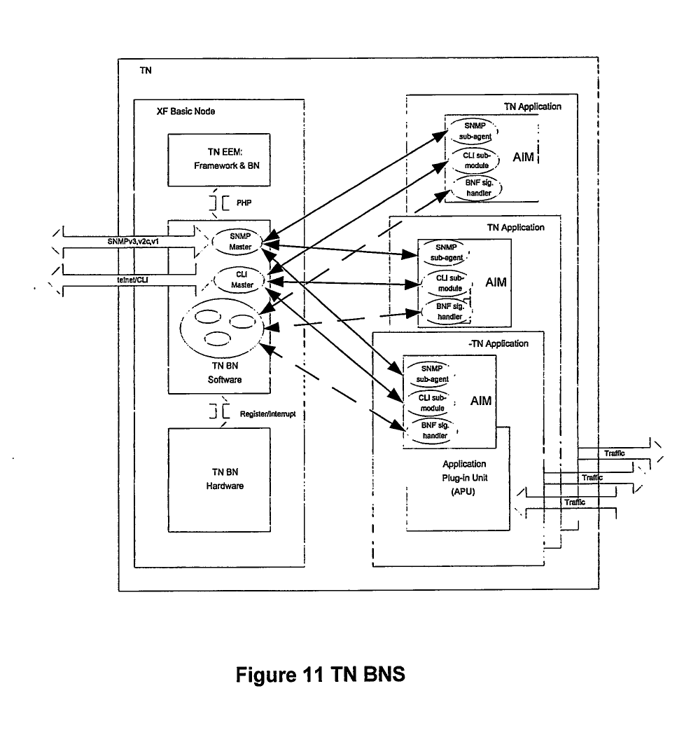

Both protocol peers on the application side are contained in the Application Interface Module (AIM) as shown in FIG. 11.

TN Hardware Architecture

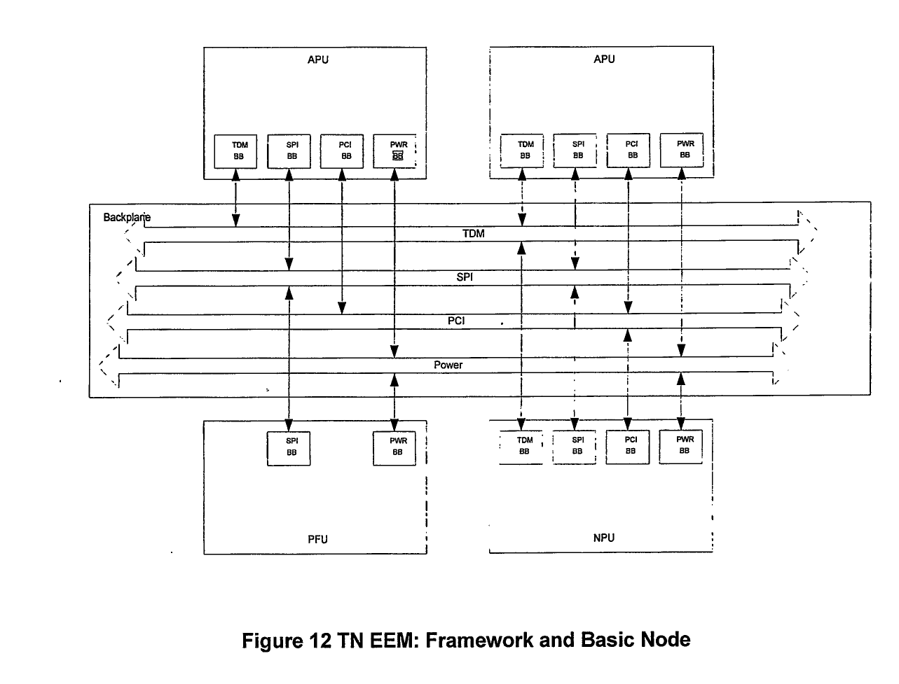

The Traffic Node's hardware architecture consists of Basic Node Hardware; (BNH) in which Application Plug-in-Units (PIU) e.g. APU can be placed. The BNH provides various communication busses and a power distribution bus between the various PIUs in the TN. The buses them selves are part of the backplane, i.e. TN BN, whilst PIUs interface to these buses through TN BNH Building Block (BB) as shown in FIG. 12.

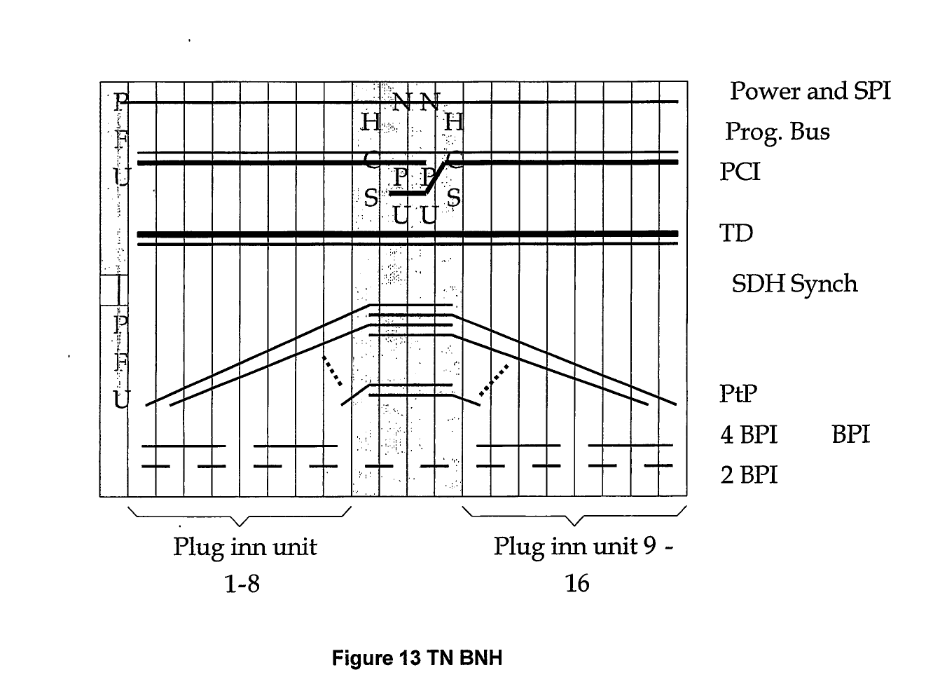

As an illustrative example FIG. 13 shows the buses and their location on the AMM 20p backplane.

In the next sections these buses and their corresponding building blocks will be discussed.

SPI Bus

SPI is a low speed synchronous serial interface used for equipment handling and control of:
APU cold and warm resets
status LEDs and block received signals (BRS)
Inventory data, like product number, serial number, asset identifier etc.
Temperature supervision
Power supervision
BPI disable/enable
PCI fault handling
General purpose ports The SPI BB is implemented in a Complex Programmable Logic Device (CPLD). The SPI bus and BBs are part of TN's control system.
   PCI Bus

The PCI bus is a multiplexed address/data bus for high bandwidth applications and is the main control and management bus in the TN-Node. Its main use is communication between NP Software (NPS) and Application DP Software (ADS), TDM BB and ASH like Line Interface Units (LIU). The PCI bus is part of the control system. The PCI BB is implemented in a Field Programmable Gate Array (FPGA).

TDM Bus

The TDM bus implements the cross-connect's functionality in the TN. Its BB is implemented in an Application Specific Integrated Circuit (ASIC). Typical characteristics are:
32 port per ASIC, where each port can have a capacity of 8 kBit/s to 45 MBit/s
The bus with TDM BBs provides a non-blocking switching capacity of ˜400 E1 ports (800 Mbit/s), i.e. 200 bi-directional cross-connects.
Redundant switching function
Cross connection
Routing DCN to the IP router on the NPU.
Support for PDH synchronization hierarchy.

TDM bus and its BBs are part of the traffic system.

Power

The power distribution system may or may not be redundant, this will depend on the specification wanted, however, one has to install two PFUs, as being part of the traffic system. DC/DC conversion is distributed and present at every PIU.

Synchronisation Busses

The PDH synchronisation bus provides propagation of synchronisation clock between PIUs as well distributes the local clock.

The SDH synchronisation bus provides propagation of synchronisation clock between PIUs.

Being part of the traffic system, both PDH and SDH synchronisation busses are redundant.

BPI Busses

BPI-2 and BPI-4 can be used for application specific inter-APU communication. The communicating APUs must then be located in the same group of 2 respectively 4 slots, i.e. located in specific neighbouring slots in the TN rack. The BPI busses are controlled by the application.

Point-to-Point Bus

The Point-to-Point (PtP) bus is meant for future central switching of high-capacity traffic.

Programming Bus

The programming bus is intended as JTAG bus for programming the FPGAs in the node.

Basic Node Architecture

The TN BN can be divided into the two components, TN BNS, (TN Basic Node Software) and TN BNH (TN Basic Node Hardware).

Although the TN EEM is not a part of the TN BN in the product structure, in practice it is a necessary part when building TN Applications that needs to be managed by the EEM. That is why in the rest of this description the TN EEM is regarded as a part of TN BN.

These three TN BN components will interface to their peer components in the TN Application through well defined interfaces.

TN Basic Node Software

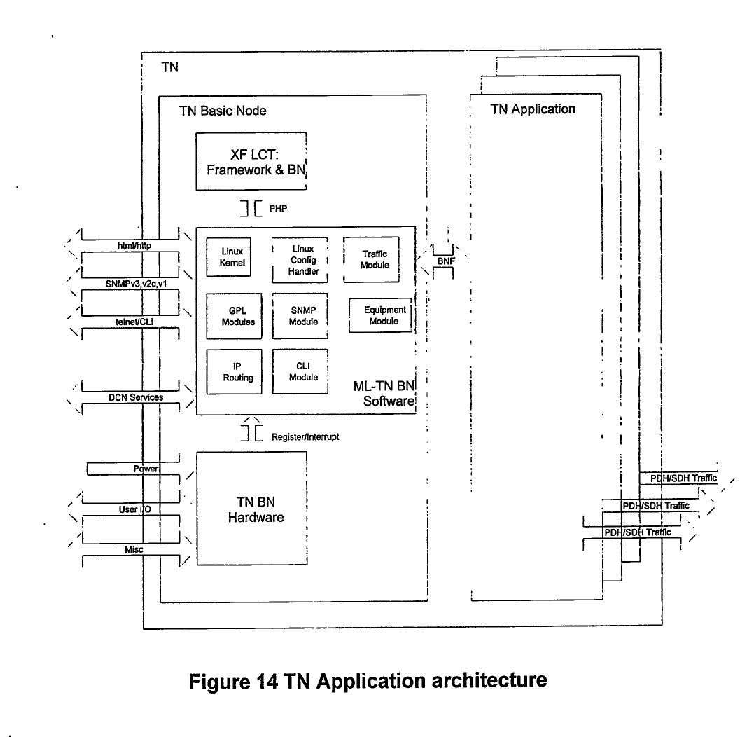

With reference to FIG. 14, the TN BNS realises control and management of the TN BN and its TN BNH BB that reside on the various APUs. Therefore it is part of TN's control system, and delivers its services to the TN Applications. It is part of the TN control system and not of the traffic system.

The main Basic Node architectural concept is its distributed nature. For the SNMP and CLI interfaces there is a Master/Sub-Agent architecture, where the master acts as a postmaster and routes requests to the sub-agents as shown in FIG. 11. Each sub-agent handles its part of the SNMP object tree or its sub-set of the CLI commando's.

TN BNS External Interfaces

The TN BNS provides the following external interfaces:

HTML/HTTPS, the embedded manager, TN EEM, sends HTML pages to a browser on the operator's computer. HTTPS is used for providing encryption especially on the username and password of the HT pages.

DCN Services, various IP protocols such as:
DNS
NTP for synchronisation of the real-time clock
FTP for software upgrade and configuration up/download
Telnet for CLI configuration
DHCP for TN acting as an DHCP relay agent
CLI, over Telnet, limited configuration of the TN through Cisco like commands.
SNMP, O&M interface using SNMPv3 to configure the node, gets it status and send traps to the manager.

Configuration by means of SNMPv1/v2 is optional.

TN Embedded Element Manager

The TN can be managed through either the SNMP interface or a WEB based embedded manager. This embedded manager consists of two parts:

A WEB-server located in the TN BNS able to execute PHP script
HT pages with embedded PHP script, denoted as TN EEM. These pages can be divided into three categories:
Framework, generic pieces of HTML/PHP code part of the TN BN
Basic Node management, part of TN BN
Application management, AWEB, part of the TN application

The WEB server receives an URL from the EEM and retrieves the page. Before sending the page to the EEM it interprets the PHP code, which is replaced with the return values of the PHP call. The WEB-server interfaces to the SNMP-master in the TN BNS by executing the PHP SNMP function calls. The TN EEM is part of the TN control system.

As described above the TN EEM interfaces to the WEB-server in the TN BNS through HTML with embedded PHP script.

TN Basic Node Hardware

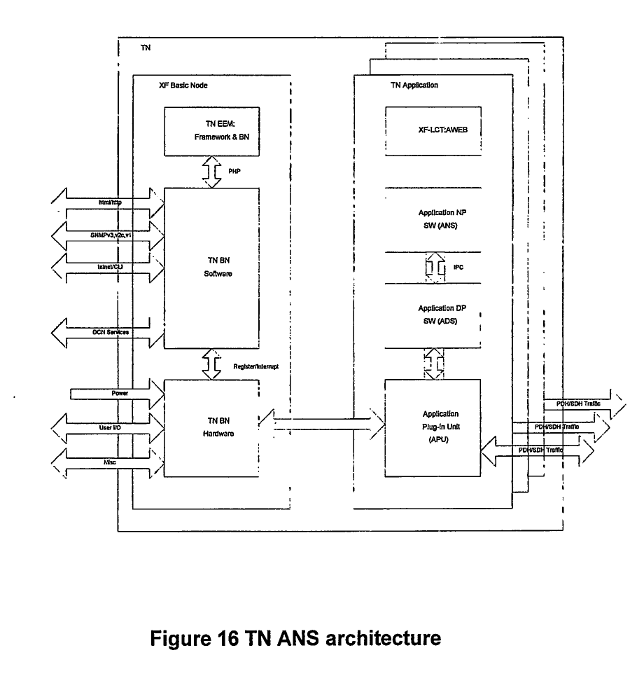

The TN BNH consists of (refer FIG. 16):
TN BN backplane providing the previously described busses
Building blocks that enable APUs to interface these busses:
   SPI
   PCI
   Power
   TDM
   TN BN PIUs:
   NPU, Node Processor unit running TN BNS and ANS. The NPU also provides:
   8 E1 Traffic Interfaces
   V.24 interface
   Ethernet interface
   3 digital input and outputs
   PFU, Power Filter Unit providing power to the other PIUs.
   FAU, although not a real PIU in the sense that it is not coupled directly to the busses in the backplane.

TN BN Mechanics:

Rack, providing space to 20 or 6 large format PIUs (i.e. excluding PFUs and FAU)

The BNS-BNH interface is register and interrupt based.

Application Architecture

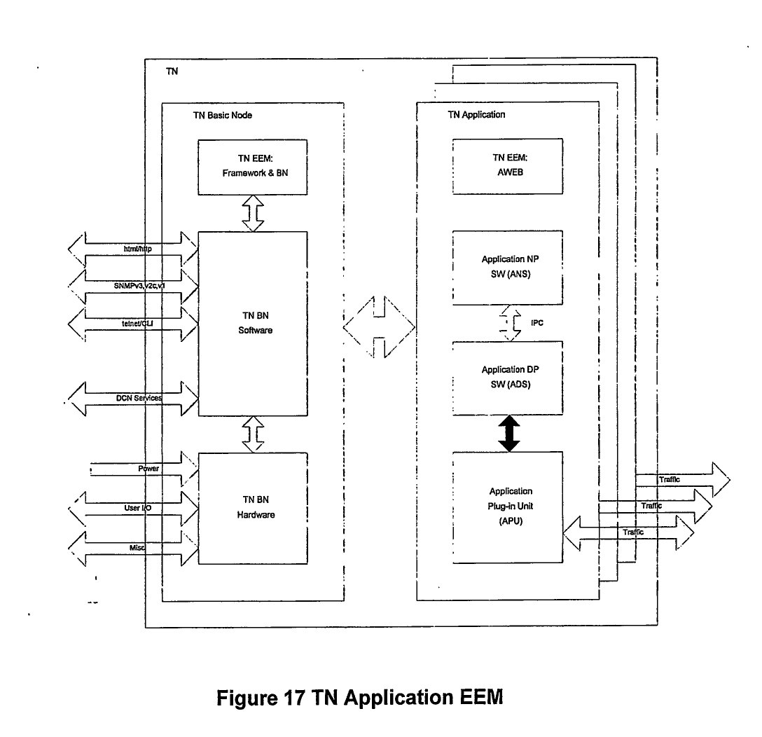

FIG. 17 shows the internal components of a TN Application that will be discussed in the following sections:
TN EEM: AWEB, application specific HTML/PHP pages for management of the application
ANS, Application Node Software is the software needed for the application running on the NPU, i.e. on Linux OS.

ADS Application Device Software, is the software running on the processor on the APU, in case a processor is present.

APU, Application Plug-in Unit, is the application board.

TN Application Software (ANS+ADS)

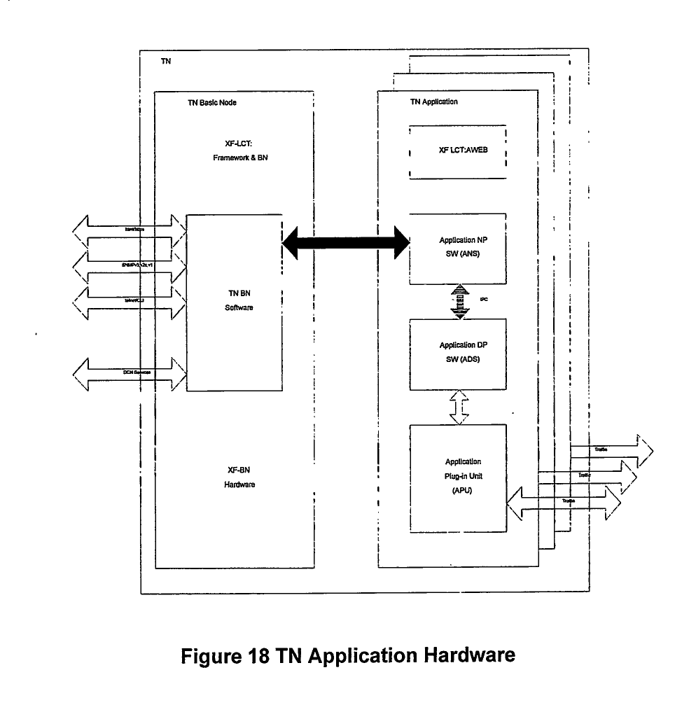

The application software consists of (cf. FIG. 18):

ANS running on the NP (see FIG. 18) on the NPU. This software is running even if the corresponding APUs are not present in the TN. It is the control software for the application, and as for all software on the NPU, failure will not cause traffic disturbance.

ADS is located on the APU if the APU houses one or more processors.

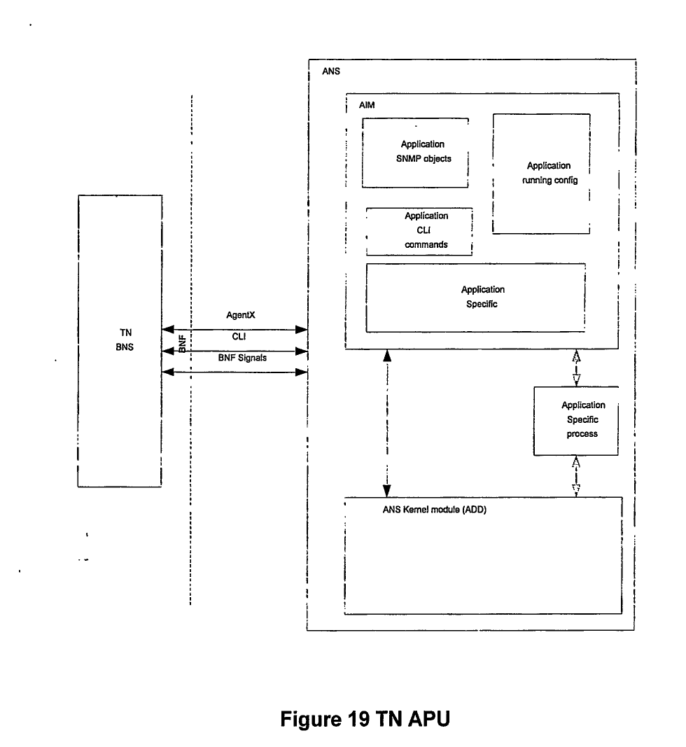

FIG. 19 shows the internal ANS architecture, where the AIM, Application Interface Management module, houses SNMP and CLI sub-agents that are responsible for the application specific SNMP objects/CLI commands.

The ADD, Application Device Driver, contains application specific device drivers and real-time ANS functions.

The architecture of the ADS is very application specific and interfaces only to the ANS and not to any part of the TN BNS directly.

Interface Towards BNS

The BNF, Basic Node Function, provides the interface between ANS and BNS. It comprises 3 sub-interfaces:
CLI, protocol for the AIM for CLI sub-agent to CLI-master communications. Used for e.g. persistent configuration storage.
AgentX, protocol for the AIM for SNMP sub-agent to SNMP master communications. Used for SNMP configuration and alarms etc.
BNF Signals for message based communication between AIM and BNS. This can in principle also be used between other processes.
   TN Application EEM

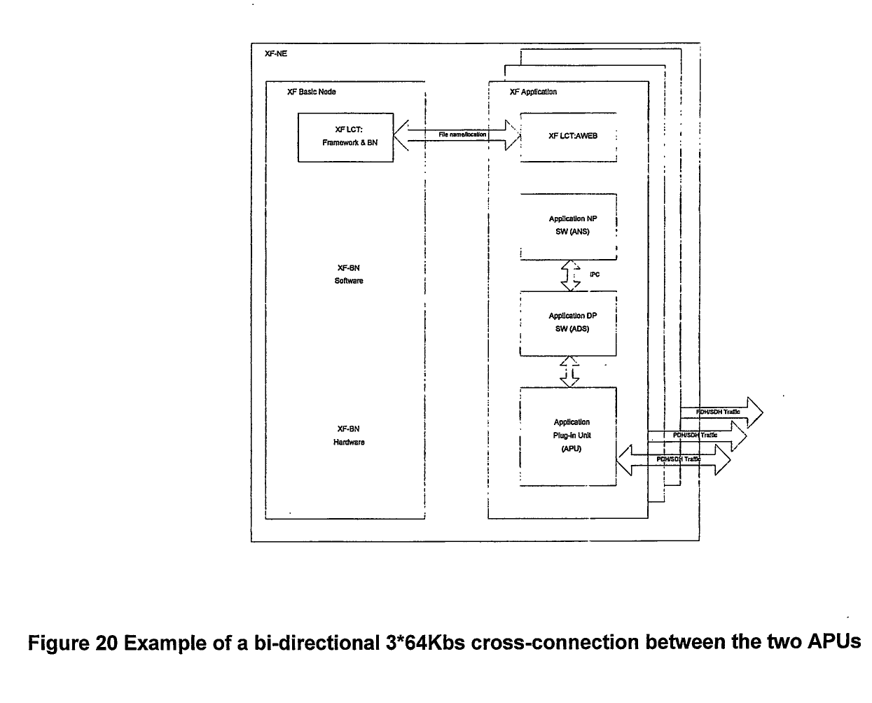

With reference to FIG. 20 the application specific WEB pages are located on the NPU. These pages contain HTML and PHP script that is executed by the WEB-server in the TN BNS. The WEB-server executes the PHP SNMP function calls and talks to the SNMP master, which its turn delegates the request to the SNMP sub-agent residing in the AIM of the respective ANS.

Interface Towards Tn EEM

The AWEB interfaces to the rest of the TN EEM through a naming convention for the respective HTML/PHP files.

TN Application Hardware

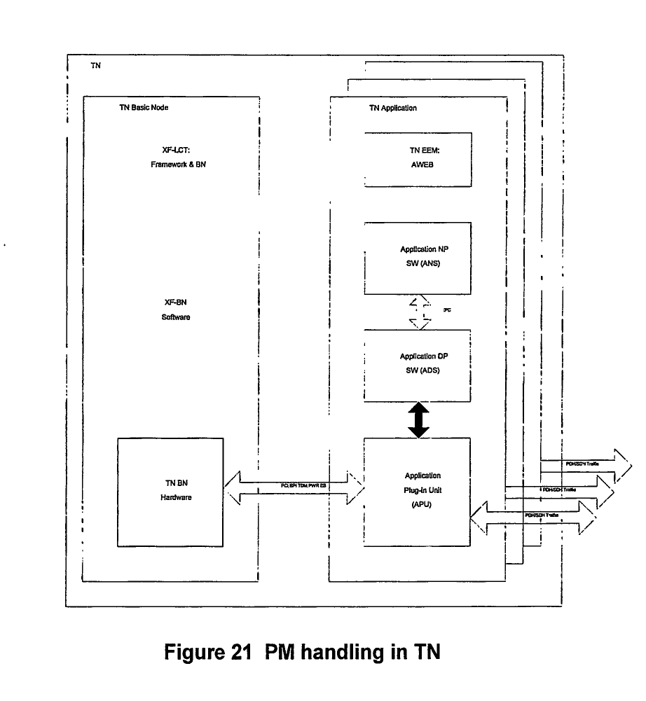

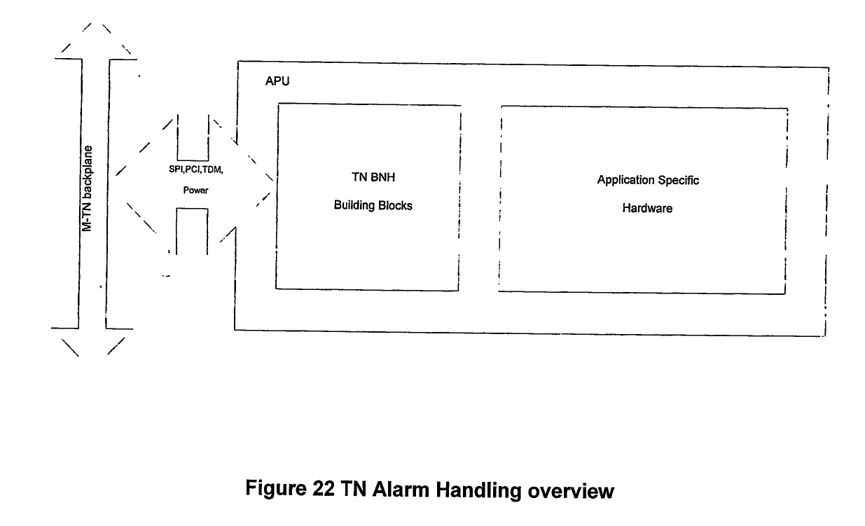

The hardware of the application is called an APU, Application Plug-in Unit. The application specific hardware uses the TN BNH BBs, for interfacing to the TN BNH and so to the other PIUs in the TN as shown in FIG. 21. FIG. 22 shows how and APU is build-up from Application Specific Hardware (ASH) and the TN BNH BBs. The APU interfaces mechanically with the TN BNH rack and backplane.

TN Functionality

In this section the TN functionality as described in the various Functional Specifications is mapped onto the architecture described previously.

Equipment Handling

Equipment comprises of:
Installation and repair
Restart
Supervision
Inventory and status
Node Configuration Handling
   Inventory and Status

The SPI bus is used for scanning the TN for PIUs, Hardware inventory data of these PIUs is retrieved from the SPI BB by the TN BNS EHM, through a SPI device driver. This data is represented in both the ENTITY-MIB as well as the TN-MODULE-MIB handled by the EHM.

Inventory data on the software on the various APUs is handled by the corresponding ANS that holds its part of inventory table in the TN-SOFTWARE-MIB.

Equipment status on the TN and PIUs is partly controlled through the SPI BB for faults like high temperature, restart and board type. Other possible faults on equipment are communicated from ANS to EHM in the BNS. These faults will often be communicated over PCI from an ADS to its ANS.

Equipment Installation and Repair

Installation of a new TN is regarded as part of equipment handling, but is actually a set of sub-functionalities like DCN configuration, software upgrade password setting (SNMP Module) and configuration download under direction of the Equipment Module.

Hot-swap is supported to enable plug & play on all PIUs except NPU. It uses both SPI and PCI busses and is the responsibility of the Equipment Module in the BNS. Plug & play for PIUs that have to be repaired is realised by saving the PIUs configuration for τ₆ period of time after it has been removed. A new PIU of the same type can then inherit this configuration when inserted within τ₆ after removal.

Restarts

The node and APUs can be cold and warm restarted as a consequence of external management requests or software/hardware errors. Warm restarts will only affect the control system whilst a cold restart also affects the traffic system. Cold and warm restarts of APU are communicated using the SPI.

Node Configuration Persistence

Running configuration is stored persistent in the TN's start-up configuration file in flash memory. The CLI master in the TN BNS invites all TN BNS modules and the AIMs in the ANS to submit their running configuration to the start-up configuration file.

Saving the running configuration will also lead to saving the new start-up configuration file to an FTP server using the FTP client in the TN BNS.

Supervision

The following sub-systems are supervised for software/hardware errors:
NPU Processes by a watchdog reporting errors in an error log available to management.
ANS supervision;
the Equipment Module will poll the AIM to check whether it is alive, using a BNF call
the AIM monitors its ANS internal processes
the ANS is responsible for supervision of the ADS processes and DP-NP communication links (SPI & PCI)
PCI bus
SPI bus
APU supervision of power and temperature is supervised by the BNS using the SPI.
FAN Supervision through SPI by the BNS.

Detection of errors will in most cases lead to a restart or reset of the failing entity as a identification and repair mechanism.

Traffic Handling

Traffic handling functionality deals with traffic handling services offered by the TN BN to the TN Applications. The following sections describe sub-functions of traffic handling.

Cross Connect

Cross-connections between interfaces, offered by applications to the TN BN, are realised in TN BNH by the TDM bus and the TDM BBs, under software control by the traffic handler in the TN BNS. Applications register their TDM ports indicating the speed. After this TN BN can provide cross-connections with independent timing of the registered ports.

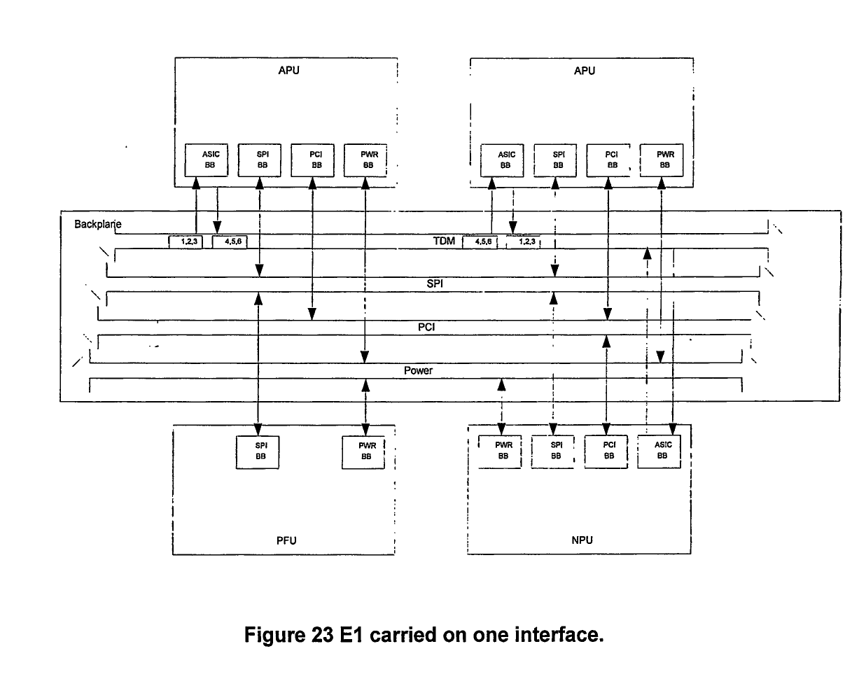

Bit pipes offered by applications on TDM ports are chopped in 64 Kbps timeslots which are sent on the TDM bus and received by another TDM BB on the bus and compiled into the original bit-pipe. FIG. 23 shows an example of a cross-connection.

Example of a bi-directional 3*64 Kbs cross-connection between the two APUs is given in FIG. 23.

Sub-Network Connection Protection SNCP provides 1+1 protection of connections in the network, offered by the TN Applications on TDM ports, over sub-networks. Outgoing traffic is transmitted in two different directions, i.e. TDM ports, and received from one of these directions. Faults detected on the receiving line cause the TN BNS to switch to the TDM port from the other direction. As with cross-connections, SNCP is implemented in TN BNH by the TDM bus and TDM BBS. TN BNS traffic handler controls management of the SNCPs.

Main characteristics of the SNCP are:
permanently bridged
unidirectional switched
non-revertive
requires no extra capacity on the TDM bus
part of control system.
   Equipment Protection

Equipment protection is provided by TN BN in the form of the TDM bus, the TDM BBs and BNS. It provides protection between two APUs based on equipment failures. An application can order this service between to APUs from BNS. BNS will then set-up the TDM BBs on both APUs and switch from one TDM BB to the other upon an equipment failure.

Performance Management

BNS, and more precise the ASIC DD, collects performance report on TDM ports every τ₁, from either the TN Application, the ADD in the ANS, or from the TDM BB. This data is reported further to the Performance management in the traffic module of TN BNS. Here the TN BNS offers the service to update current and history performance records of the TDM port based on the T₁ reports. These performance records are available to the ANS to be presented to management in an application specific SNMP MIB.

To have synchronised PM intervals applications will collect their application specific PM data based on the same τ₁ signal as the BNS.

The TN BNS, or more specific the traffic module, also keeps track of performance threshold crossings in case of TDM BBs.

Connection Testing

For testing purposes the TN BNS provides a BERT service to applications. Where a PRBS can be sent on one port per ASIC per APU concurrently and a BER measurement is performed in the receiving direction.

For protected connections, i.e. SNCPs, one BERT s provided per node.

The TN BNS also realises connections loops on the TDM bus by programming the TDM BB to receive the same time-slot as transmitted.

On the physical transmission layers line and local (or inward) loops can be used in the fault location process.

Alarm Handling

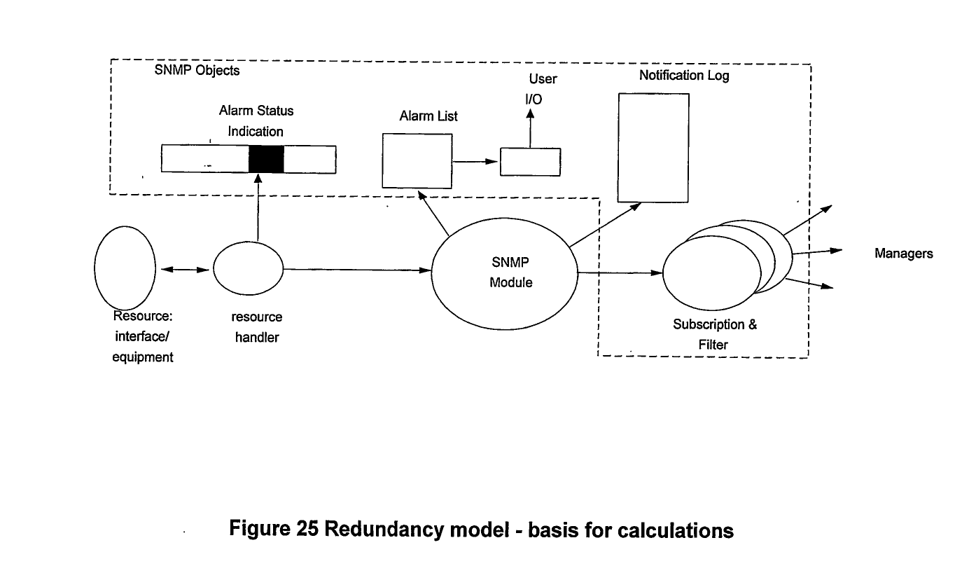

An overview of the alarm handling is illustrated in FIG. 25. Defects in the TN, that need to be communicated over the SNMP interface to a manager, are detected by the corresponding resource handler. The resource handler, e.g. an ANS or BNS process, will be first informed about the defect through SPI or an ADD that reports over PCI. The defect will be reflected in the SNMP status objects hold by the ANS.

Alarm suppression is performed in the TN in order to prevent alarm storms and simplify fault location. For this purpose defects for various sources are correlated. An application can do this for its own defects but can also forward a defect indication to the BNS in order to suppress BNS alarms. A general rule is that equipment alarms suppress signal failure alarms who in their turn suppress performance alarms. Also lower layer (closer to the physical layer) alarms will suppress higher layer alarms.

Using the AgentX interface the AIM will report an alarm for the defect to the Alarm handler functionality in the SNMP module in the BNS. Alarms will be stored in a current alarm list and a notification log. It is then up to the manager to subscribe on these notifications that are sent a SNMP traps in IRP format.

Software Upgrade

The software upgrade functionality allows the operator to download a new System Release, which consists of a NPU Load module and several DP load modules, on a node per node basis. Topology and available DCN bandwidth may allow for several nodes to be upgraded concurrently. However, which upgrade strategy is used is up to the NMS.

The TN BNS upgrades its self plus all ANS. The ANS are responsible for upgrading the corresponding DPs using the TN BNS's FTP client and RAM disk as temporary storage medium before transporting the load module to all the APUs over PCI to be stored into the APU passive flash memory. This happens while the software in the active flash memory is executed.

The software upgrade process is fail-safe in that respect that after a software upgrade the operator has to commit the new software after a test run. If a commit is not received by the node, it will fall back to the old software. It is also possible for the node to self execute a rudimentary test without the need for the operator to commit.

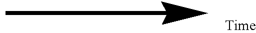

| Phase | Inform | Upgrade | Restart | Test/Commit | Active |
|---|---|---|---|---|---|
| De- | TN | TN | TN warm | Manager/No | After |
| scrip- | retrieves | downloads | restart | de commits | commit |
| tion | information | (FTP) all | to test | new | new |
| | on the | load | new | software. | system |
| | system | modules | software. | Failure | release |
| | Release | that | | leads to | is |
| | and load | require | | software | active. |
| | modules | an | | fall-back | Only a |
| | to | upgrade | | | fall- |
| | upgrade | in to RAM | | | back on |
| | to. | disk at | | | NPU |
| | | NPU and | | | software |
| | | burns | | | can be |
| | | them into | | | per- |
| | | the | | | formed. |
| | | NPU/APU | | | |
| | | passive | | | |
| | | flash | | | |
| | | memory. | | | |

Traffic Node Availability Models and Calculations

In the following a description regarding the availability calculations and corresponding models is given, models that serve as the basis for the design of the TN. It also includes the calculated failure rates and MTBR figures for the TN.

Prerequisites

The reliability calculation for the TN connections are based on the following prerequisites:

Calculation Method

All calculations are based on MIL-HDBK-217F Notice 1 with correction factors. The correction factor is based on actual experience data and compensates for the difference in use of a commercial and a military system. A military system is normally used for a short interval with long periods of storage whereas a commercial system is in constant use.

E1 Connection

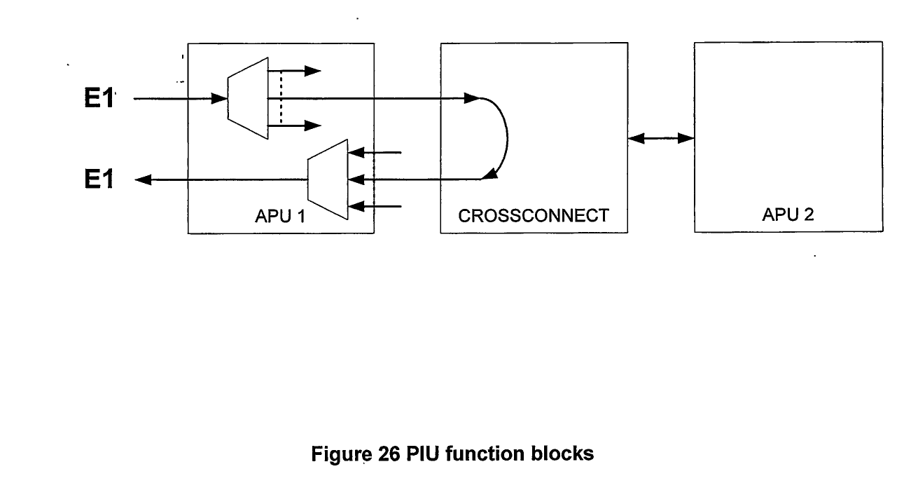

The connections are bi-directional connections on one interface type (FIG. 26).

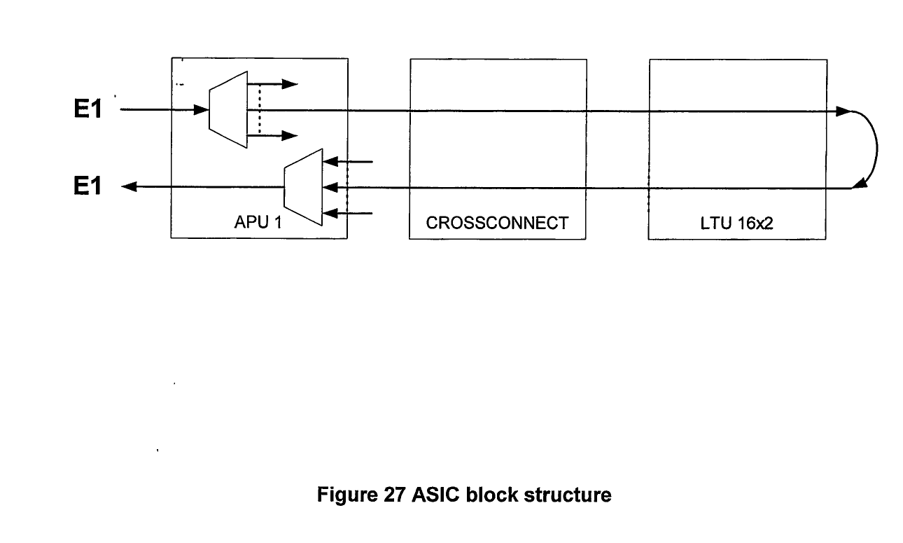

For terminals the picture as shown in FIG. 27, applies.

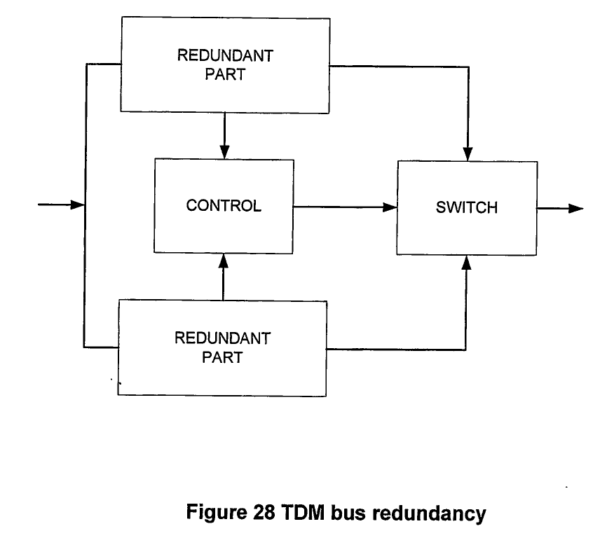

Redundancy Model (FIG. 28)

The calculations are based on the general model. With fault detection in the control parts, with λ_{R}=λ_{S}, μ_{R}=μ_{U}=μ_{C} (μ=1/MTTR). Generally μ_{U} can be expected to be shorter as a service affecting failure will be raised as a major or critical alarm.
U=(2λ_{T}+λ_{C}+6λ_{T}λ_{C}/μ)λ_{T}/μ², and as λ=U*μ,λ=(2λ_{T}+λ_{C}+6λ_{T}λ_{C}/μ) λ_{T}/μ
MTTR

MTTR=24h, (μ=μ_{U}=μ_{C}=1/MTTR=1/24) This is a simplification as the traps indicating faults are divided into the categories: warning, minor, major and critical. The simplified meanings of these severities are: information, control function failure, loss of redundancy and loss of traffic. It is reasonable to expect a short MTTR to a critical alarm whereas a warning or minor may have a longer MTTR. Still 24 h is used as a common repair time.

Temperature

The calculations are related to a 40° C. ambient component temperature. The TN-E estimates are all done at 40° C. and the correction factor may include temperature compensation if the actual temperature is different from this. Therefore the TN estimates are set at the same temperature. The correction of the temperature at some units is related to the specific cases where the units are consuming little power and thus have a relative temperature difference with respect to the other units.

PIU Function Blocks

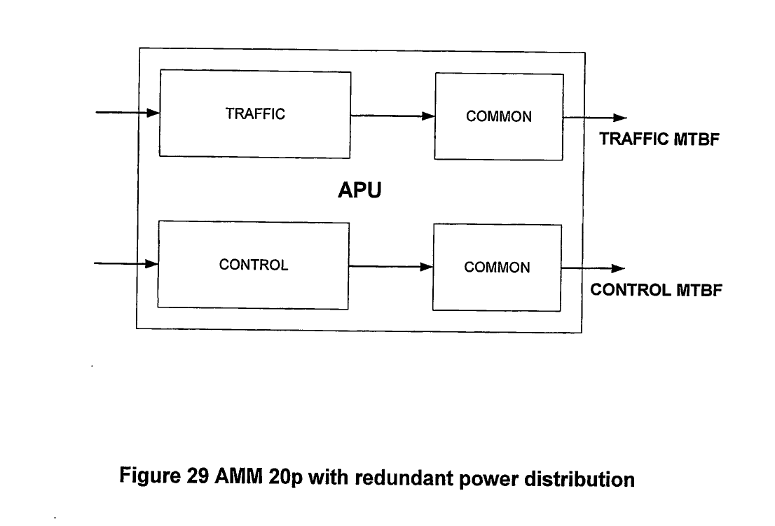

All PIUs are divided into three parts, control, traffic and parts common to both. This gives the simple model for the traffic and control function shown in FIG. 29.

The control part represents any component whose failure does not affect the traffic. The traffic part is components whose failure only affects the traffic. The common part is components that may affect both the traffic and the control. Some examples:
Traffic: ASIC, BPI, Ella, interfaces, muxes
Control: PCI, DP, SPI EEPROM
Common, Power, SPI CPLD, SPI temp sensor

The control block and the traffic block are repaired individually through separate restarts.

The General Tn Availability Models

Basic Node Availability Models

Cross Connect

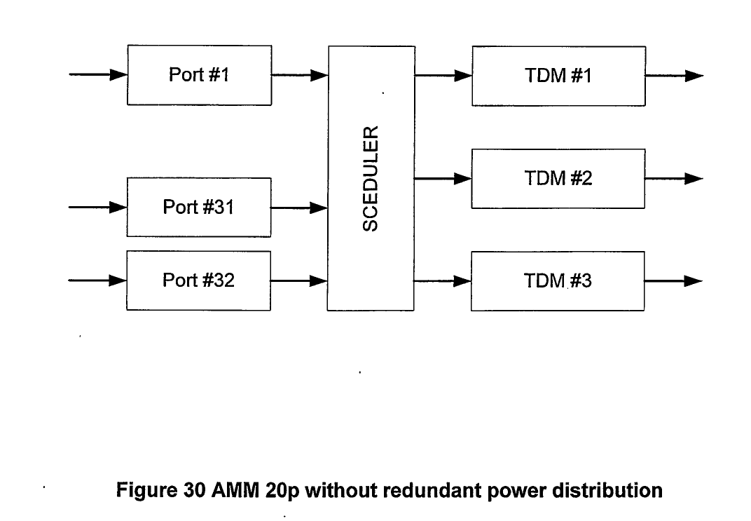

The cross-connect function in the TN is distributed and is implemented through the ASIC circuits, FIG. 30 shows ASIC block structure.

The failure rate of an E1 connection through the ASIC is not the same as the MTBF of the circuit. The ASIC is divided into a port dependant part and the redundant cross-connect. The failure rate of one port (including scheduler) is 20% of the ASIC MTBF and the TDM bus (cross-connect) is 30% of the ASIC MTBF.

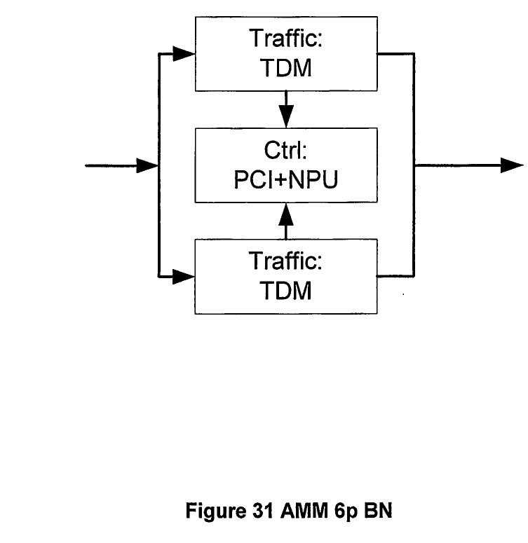

The model for the redundant cross-connect can be seen in FIG. 31.

From the following can be seen:
U_{cross connect}=(2λ_{TDM}+λ_{PCI+NPU-C}+6λ_{TDM}λPCI+NPU-C/μ)λ_{TDM}/μ²

As can be seen the TDM bus redundancy improves the failure rate by a factor of more than 50000. This makes the TDM bus interface insignificant and it is therefore omitted from the calculations. The ASIC contribution to the E1 failure rate is then 20% of the ASIC MTBF. This contribution is the port reference in the general availability model.

AMM 20p

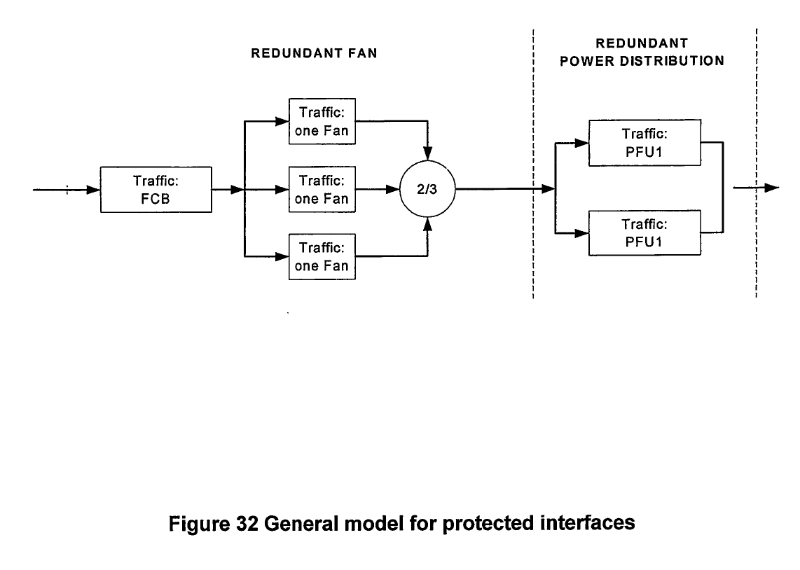

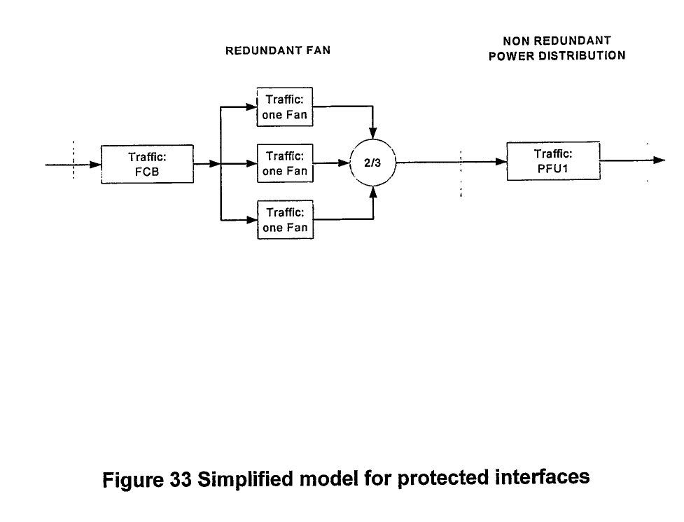

The AMM 20p can be equipped with or without redundant PFUs. The two models for this are shown in the two FIGS. 32 and 33. (FIG. 32 AMM 20p with redundant power distribution, FIG. 33 AMM 20p without redundant power distribution). The fan (FAU1) consists of one fan control board (FCB) and 3 fans. If one of the 3 fans fail a notification will be sent and the two remaining fans will maintain cooling in the repair interval. The FCB powers all 3 fans and is therefore a common dependency.

The power distribution in the AMM20p is redundant but the node may be equipped without redundant PFUs if so desired. The power distribution has a very high-reliability even without the redundancy. This option is therefore generally viewed as a protection against failure of the external power supply rather than the node power distribution.

There is no dependency to a control function for the switchover between the redundant parts for the power or the fans.

The unavailability in a 2 of 3 system is given by the equation:
U_{2/3}=Uᵢ²(3−2Uᵢ) where Uᵢ is the unavailability of one branch.

The Power distribution when redundant is a 1 of 2 system. The unavailability of this is given by the equation: U_{1/2}═Uᵢ²

AMM6p

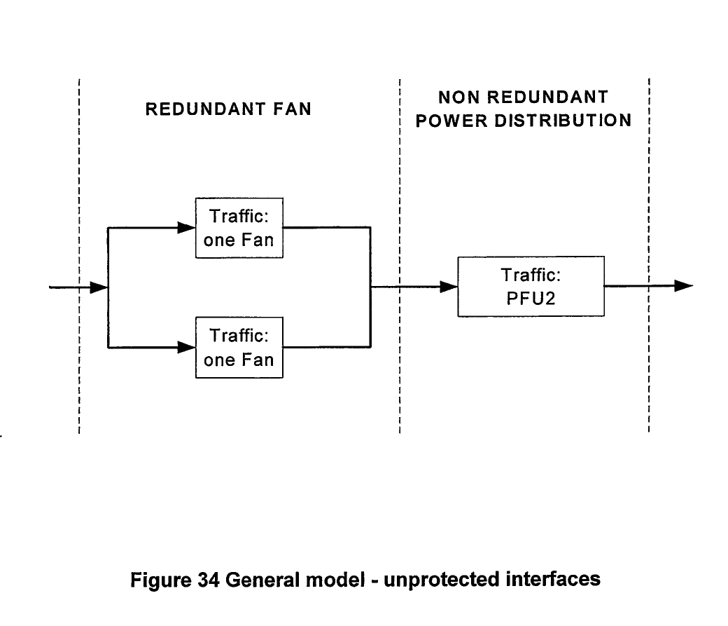

The model for the AMM 6p is shown in FIG. 34. The fan (FAU2) consists of one PCB with 2 fans. If one of the 2 fans fail a notification will be sent and the remaining fan shall maintain cooling in the repair interval. There is no dependency to a control function for the switchover between the redundant parts for the fans.

The fan is thus a 1 of 2 system. The unavailability of this is given by the equation: U_{1/2}=Uᵢ²

General Availability Model—Protected Interfaces

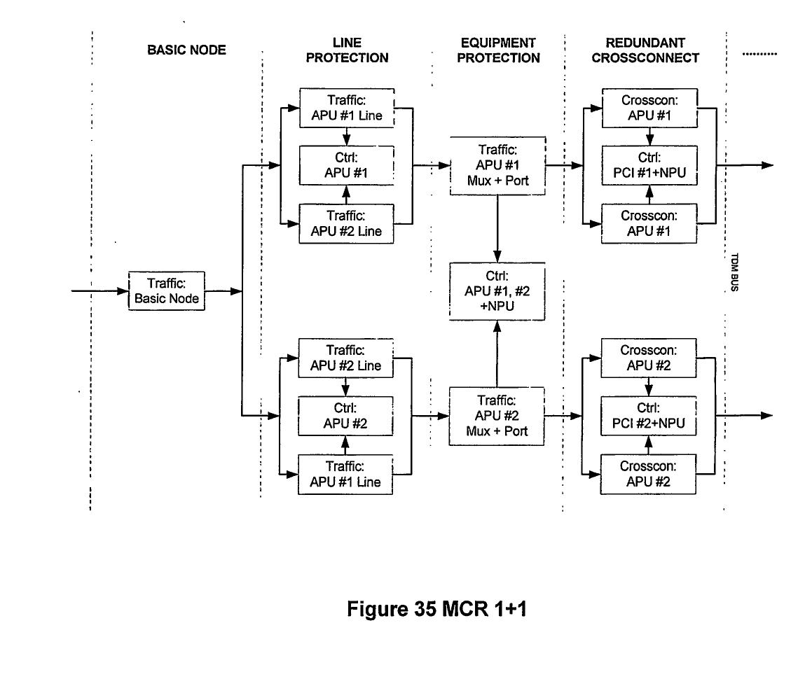

With reference to FIG. 35 a discussion regarding the general model for protected interfaces is given below. This model is the basis for the design of protected interfaces in the TN node.

The level of redundancy in the basic node depends on the type of basic node. The cross-connect is redundant. This is always in operation and may not be turned off.

The line and equipment protection schemes vary from application to application. Generally the line protection is much quicker and is intended to maintain connectivity during line faults. The requirement is therefore that the traffical disruption as a consequence of line faults shall be less than τ₄, typical msec range. The equipment protection is allowed to be slower (τ₅ typical a few sec.) as the MTBF of the protected parts are much better. Note that the line protection will repair many equipment faults as well.

Simplified Model—Protected Interfaces

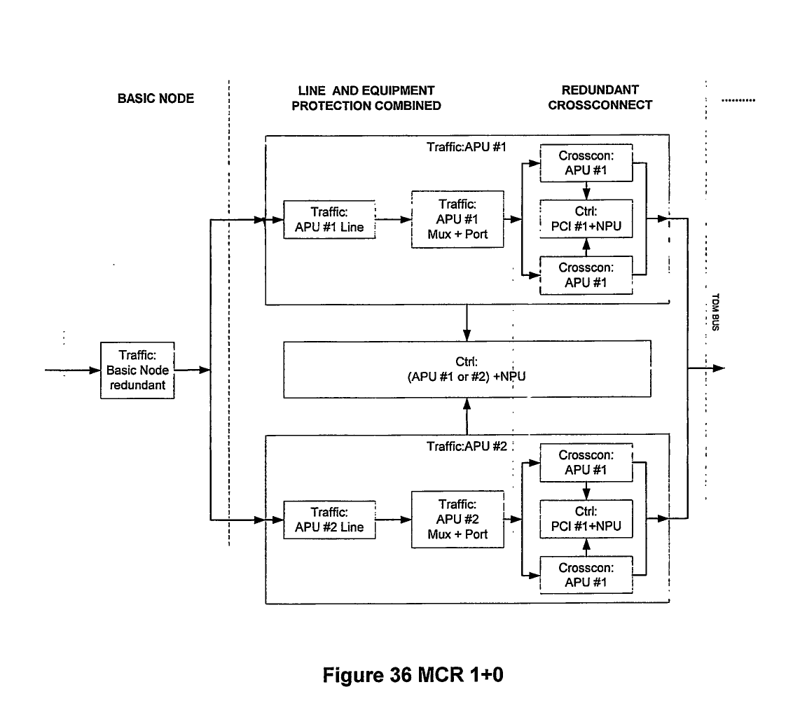

FIG. 36 shows a simplified model, which is used for the calculations described in the following.

This model is used as the basis for the actual calculations as the separation of the blocks in the general model may be difficult. As an example of this consider a board that has the SDH multiplexers and the SOH termination in the same circuit. The line protection and the equipment protection availability are difficult to calculate as the circuits combine the functions. This is the case even though the implementation is clearly separated.

This model will not provide as good results as the more correct general model since the simplification views the protection mechanisms as two equipment protected PIUs without the line protection

The redundant cross-connect is omitted from the calculations. The APU port is 20% of the ASIC The traffic functions of an APU is then used with 20% of the ASIC as the basis for the calculations.

From the following can bee seen:
U₁₊₁=λ_{BN-T}/μ+(2λ_{APU-T:1+1}+λ_{(APU+NPU)-C}+6λ_{APU-T:1+1}λ_{(APU+NPU)-C}/μ)λ_{APU-T:1+1}/μ²
General Availability Model—Unprotected Interfaces

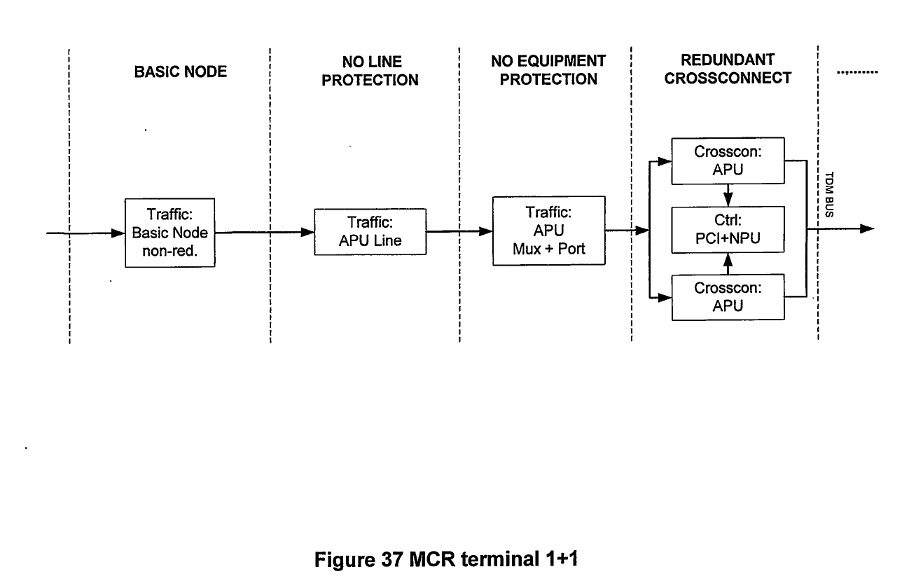

FIG. 37 shows the model for unprotected interfaces:

This model is the series connection of the Basic Node and the traffic part of an APU. Note that for unprotected interfaces the Basic Node is assumed to have non-redundant power.

MCR Availability

Prerequisites

The MMU2 MTBF calculation is divided not only with respect to control and traffic but also with respect to the use of the PIU. When the unit is used in a 1+1 configuration the ASIC and Ella are not in use. Faults will then not be discovered in these components and the components are therefore not included in the calculation.

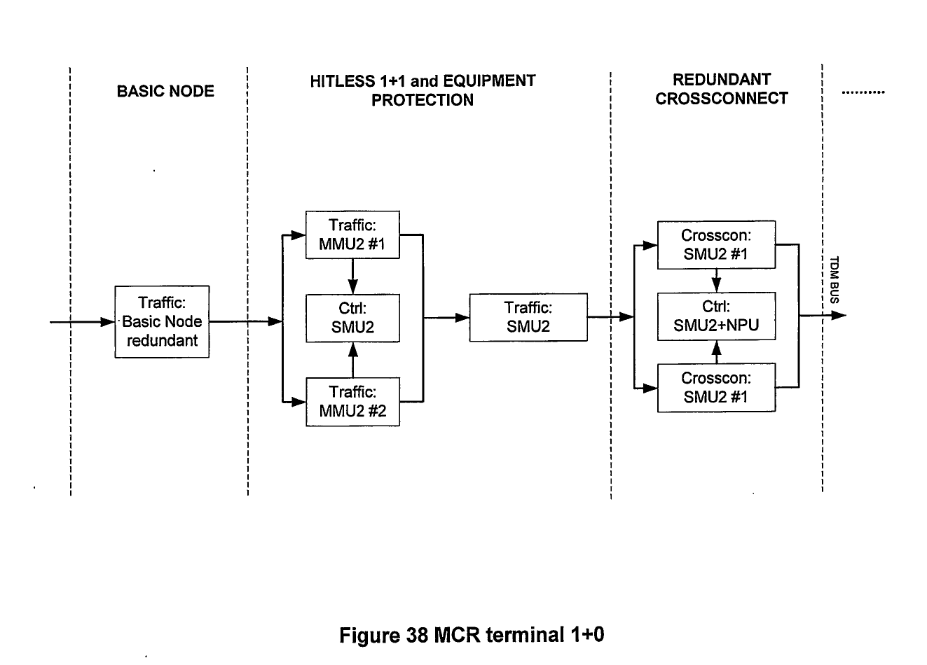

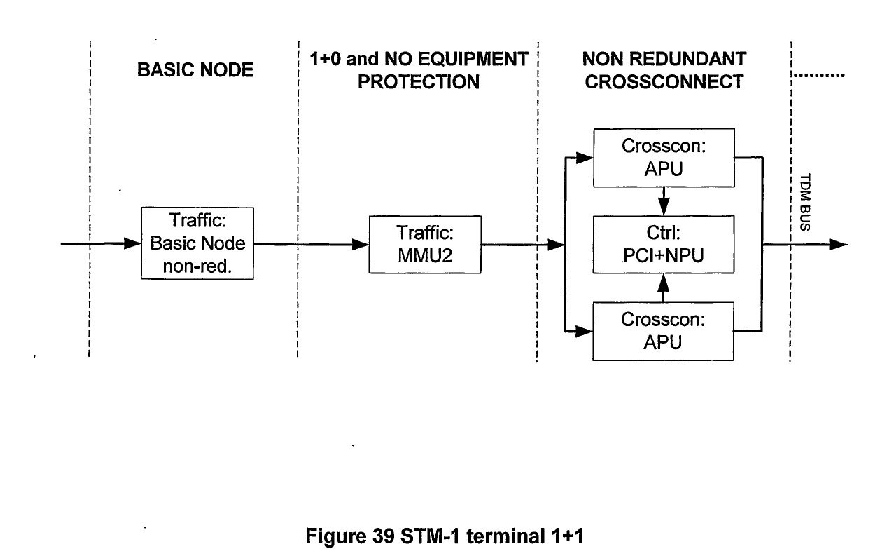

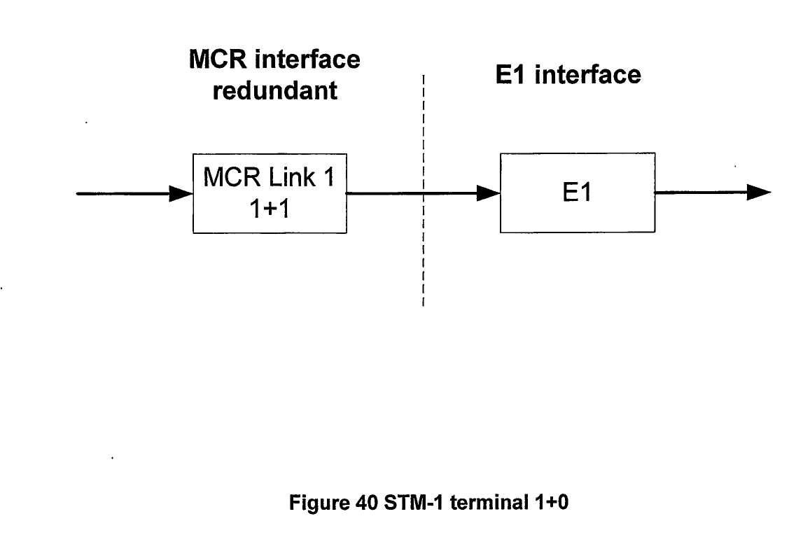

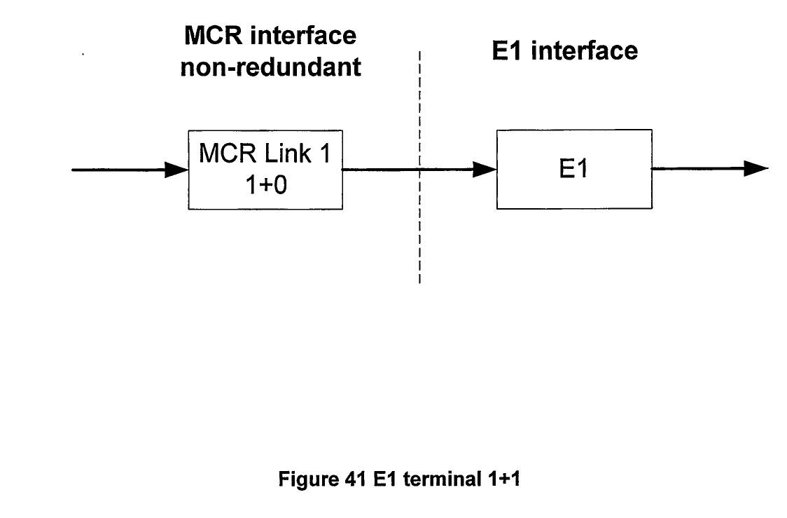

The SMU2 MTBF calculation is divided not only with respect to control and traffic but also with respect to the use of the PIU. When the SMU2 is used as a protection unit then the line interfaces are not in use. Faults will then not be discovered in these components and the components are therefore not included in the calculation. In the following it is referred to several MCR configurations, each of them shown in separate figures;
MCR: 1+1 interface, FIG. 38.
MCR: 1+0 interface, FIG. 39.
MCR: 1+1 terminal, FIG. 40.
MCR: 1+0 terminal, FIG. 41.
   STM-1 Availability
   Prerequisites

The STM-1 models are the same as the generic TN models. They are therefore not repeated here.

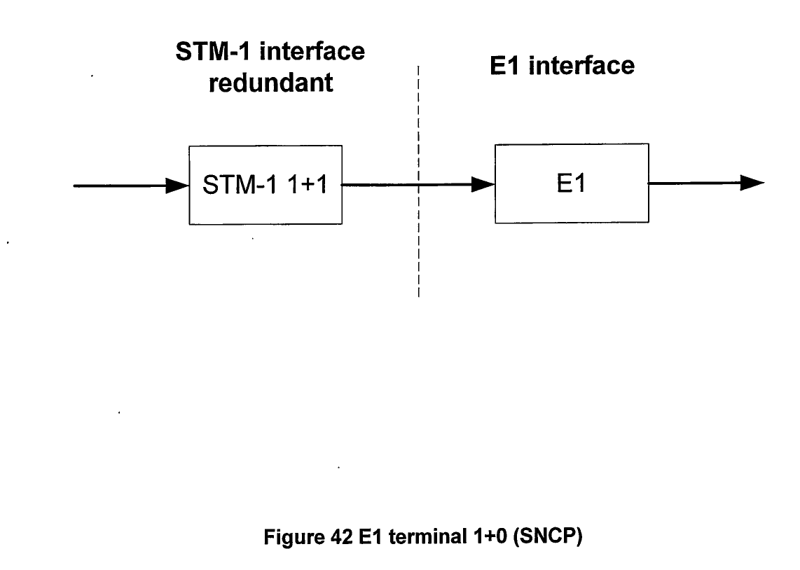

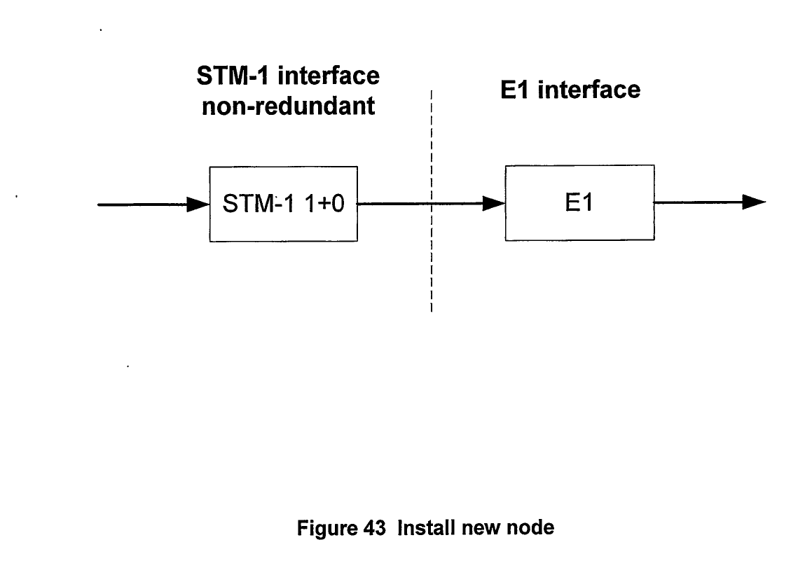

In the following it is referenced to two STM-1 models, each of them shown in separate figures
STM-1: 1+1 terminal (MSP1+1) FIG. 42.
STM-1: 1+0 terminal, FIG. 43.
   LTU 16×2 Availability
   Prerequisites

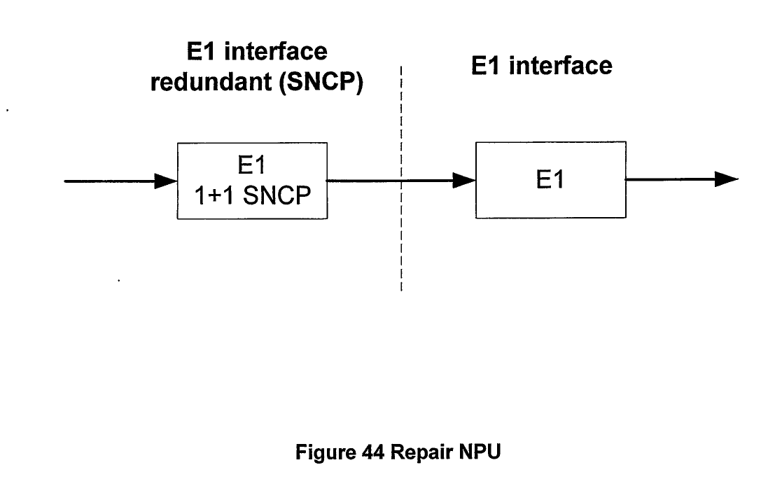

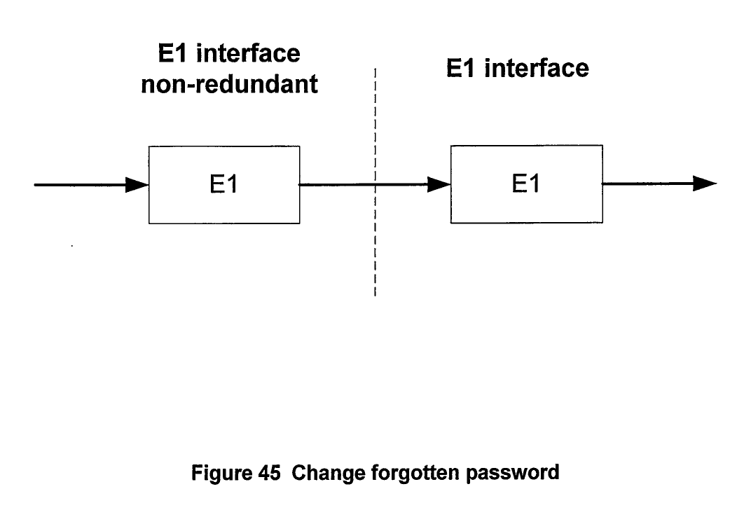

The LTU 16×2 models are the same as the generic TN models. They are therefore not repeated here. In the following it is referenced to two E-1 terminal models, each of them shown in separate figures.
E1 terminal 1+1 (SNCP), FIG. 44.
E1 terminal 1+0, FIG. 45.
   Tn, Equipment Handling
   Abstract

The following section describes hardware and software equipment handling in the TN. Examples of these functionalities are:
Equipment start/restart
Equipment supervision and redundancy
Equipment installation, upgrade and repair
Inventory management

The scope of this section is to specify the equipment handling functionality of the TN on system level. The functionality will be further detailed in Functional Descriptions (FD), Interworking descriptions (IWD) and design rules (DR).

Principles

The TN equipment handling is based on a few important principles:

Redundant Traffic System

The traffic system is required to be redundant configurable. It shall withstand one failure. It is assumed that the failure will be corrected before a second failure occurs. The fault identification is therefore required to be extensive. If a fault cannot be discovered it cannot be corrected.

This requirement makes it necessary to have redundant ATM switch and IP router slots in the sub rack.

Separated Control and Management System

The system is required to have the control system separated from the traffic system. The reason for this is that:
The control system can be non-redundant. A failure in the control system will not influence the network connectivity. This greatly reduces cost and complexity.
It simplifies in service upgrade. The control system can be taken out of service to be upgraded without any traffic impact.
It enables extensive self-tests. The control system may be reset and any kind of self-test (within the control system) may be performed. This allows for self-test that have a high likelihood of providing a correct fault localisation to be executed.
   In Service Upgrade

The system shall be in service upgradeable. This means that without disturbing the established traffic it shall be possible to:
Perform SW upgrade.

Add new PIUs (requires hot swap for all but NPU).

Remove/replace any replaceable unit (requires hot swap). If an APU is protected then the operation shall give less than τ₄ (τ₄ typical 50 msec) disturbance on the connections on that board. The operation shall not give any disturbance on any other connections.

NPU Redundancy

The TN is prepared for NPU redundancy. This is to allow for:
Higher control system availability. A failure in the control system may disconnect the DCN network. A redundant NPU may improve the control system availability and thus also the DCN availability.
Easier maintenance. The redundant NPU solution may give a local configuration file backup. This simplifies the NPU repair procedures.
   PFU Redundancy

The power supply is a prerequisite for operation of the node. Redundant power inlet and distribution is vital in order to withstand one failure.

The two power systems shall both be active sharing the load. A failure in the power system shall not result in any disturbance of traffic or control and management systems.
Double power inlet enables power redundancy in the site installation.
Redundant PFU remove all possible single point of failure in the unit.
Redundant PFU enables replacement of a PFU without any disturbance.
   The SPI Bus

The equipment handling in TN uses the SPI bus in the node as a central component therefore some of the main SPI functionality is described here.

The SPI bus is a low speed (approx. 1 Mbit) serial synchronous bus that is mandatory on all TN boards. The bus is controlled by the NPU. It is a single master bus over which the NPU may execute a set of functions towards the PIUs. These functions are:
Place the board in cold and warm reset.
Read an onboard EEPROM containing information about the board.

Set alarm thresholds for the excessive and high temperature alarms.

Control the LEDs (yellow and red) on the PIU front.

Enable/disable: 2BPI, 4BPI, PtP-BPI interfaces, programming bus (PCI), and interrupts.

Over the SPI interface the NPU will be notified of the following:
Temperature threshold crossing.
PIU Power failure.
PFU Input power failure.
BR activation
Board insertion/power-up
PCI FPGA loading completion/failure
PCI bus transaction failure.
PCI capability (does the board have it or not)
Fan failure.
Application dependent interrupts (fan failure.)

The BNS will at start-up pass on to the applications the information found on the APUs SPI block. I.e.: the BNS will receive the temperature thresholds and will need to check them for validity, if incorrect change them to default values. The BNS will need to handle the NPU and PFU in a similar manner.

The SPI interrupts will result in a trap to the ANS. The ANS may in addition read and write to the SPI functions. This may serve as a means for a very low speed communication between the ANS and the APU (use of APORT).

The ANS can give the APU access to the SPI EEPROM by enabling bypass. This functionality is intended to be used for the redundant NPU solution. It may cause problems for the BN if this function is used by an application as the NPU looses the EEPROM access.

Start and Restarts

The node has the following types of restarts:

| | |
|---|---|
| 0 | NODE WARM RESTART |
| 1 | NODE COLD RESTART |
| 2 | NPU COLD RESTART |
| 3 | APU COLD RESTART |
| 4 | APU WARM RESTART |

During a restart the hardware within the scope of the restart will be tested.

All restarts will be logged in the “error log”. The reason for the restart shall be logged.

Each restart may be triggered by different conditions and behaves differently.

Restarts may be used for repair. A self-test that fails in a warm restart shall never result in a cold restart. This would lead to a situation where a control system failure could result in a traffic disturbance. There are one exception PCI access to the ASIC will lead to a cold repair.

A restart that affects the NPU (node warm/cold or NPU cold restart) shall not change the state of any LEDs on any other boards. An APU with a service LED on (in the board removal interval) shall not have the LED turned off by an NPU restart. The board removal interval is likely to become longer but the state of the LEDs shall not change.

A restart that affects the NPU (node warm/cold or NPU cold restart) shall give a PCI reset. Thus if the NPU for some reason is reset then all APUs connected to the PCI bus will be disconnected from it. The PCI reset shall be given both before and after the NPU executes the restart.

The node warm/cold and NPU cold restart restores the configuration file.

Equipment Installation and Repair General

Main procedure:

It will be possible to request a board repair/removal by pressing the board removal switch (BR) on the front of the board. This disables traffic related alarms from the APU. The yellow LED on the board will be lit when the board can be removed. The board is now placed in cold reset.

The LED will stay lit for a first period of τ₂ (e.g. 60 sec.), board removal interval/timer. During this time the board may be safely removed.

If an APU is removed it may be replaced during a second interval of τ₆ (e.g. 15 min), board replacement interval/timer. If a new board of the same type is inserted into the same slot during this interval it will be configured as the previous board and will be taken into service automatically.

The procedure for removing a board shall thus be:

Press the BR on the front.

When the yellow LED is lit, the board can be removed within a period τ₂ and then if desired it could be replaced within a period τ₆.

APU variants:

If the board is not removed during the board removal interval it will be taken into service at the expiration of the board removal timer. This means that an APU warm restart is performed in order to take the unit into service again. Note that pressing the BR without removing the board is the same as cold starting the board.

If the board is replaced by a board of a different type than the one before it will result in a loss of the previous board's configuration.

NPU variants:

During the board removal interval the NPU does not have a HW warm reset signal asserted, but it is in a passive equivalent state.

When the NPU enters the board removal interval it will execute a PCI reset. This is done so as to ensure that if the NPU is replaced the NPU cold restart will be done without a lot of PCI bus activity. It is also done to ensure that the link layer protection mechanisms are in operation during the NPU unavailability. If the APUs where placed in warm reset the MSP 1+1 of an LTU 155 board would become inactivated.

Note that pressing the NPU BR without removing the NPU is the same as a NPU cold restart.

PFU variants

TN NE can be installed with or without power redundancy.

Loss of power result in the following notifications:

The NE operational status shall be set to: major/power failure

The PFU operational status shall be set to: critical/hardware error

Alarm will be sent to the EEM.

Fault LED on PFU on and power LED on PFU off while the power is faulty.

If administrative status is set to ‘In Service’ for all PFU (default), the system is configured with power redundancy. In order to make this possible the PFU modules has to be presented in the entity MIB even if only one PFU is installed.

FAU variants

TN NE can be installed with or without FAN unit.

If administrative status for FAU is set to ‘In Service’ (default), the system is configured with FAN unit.

In order to make this possible the FAU module has to be presented in the entity MIB even if no FAU is installed.

Basic Node Software-Application Node Software interaction:

When the BR in the front of the board is pressed, the BNS will inform the application (ANS) that the board should be taken out of service.

When the application is ready, it will report to the platform that the board can now be removed. The BN will then deallocate the PCI device drivers for the board and light the board's yellow LED. The BNS shall then place the APU in cold reset so as to avoid signals from a board which is now unavailable to the ANS.

Configuration:

Note that the Running Configuration of a board under repair will be lost if:

The node powers down.

The node/NPU restarts.

The board is not replaced within the board repair interval.

Another type of board is inserted in the slot.

When the board repair timer expires the board will be removed from running configuration and running configuration will be saved in the start-up configuration, i.e. the board can no longer be replaced without loss of the configuration.

If the save timer is running when the board removal timer expires then the configuration file save will not be executed.

BPI handling:

The applications are responsible for the BPI handling. The BPI interfaces can be enabled by the applications if required. The BPI bus shall be used by the ANS as follows:

If an ANS has 2 boards connected to the 2BPI it may be enabled. If the application with an enabled 2BPI bus has less than two boards on the bus it shall be disabled at the expiration of the board removal timer.

If an ANS has at least 3 boards connected to the 4BPI it may be enabled. If the application with an enabled 4BPI bus has less than two boards on the bus it shall be disabled at the expiration of the board removal timer.

PtP BPI shall be disabled.

The BPI busses are disabled as a consequence of a node or APU cold reset.

Installation

The following use cases require the operator to be present at site and to set the node in so-called node or NPU installation mode:
1 Installation of a new node (Node installation). The node doesn't have DCN links up and/or DCN configuration is wrong. I.e. the node is not accessible from a remote management site.
2 Change forgotten password (Node installation). Changing the passwords without the old passwords should not be possible remotely.
3 Fallback to old NPU software revision (Node installation). This is an emergency use case only applied in case a software upgrade prevents any other up/downgrades.
4 Repair of the NPU (NPU Installation). The new NPU, that replaced the defect one, has a different configuration than the previous one. I.e. the configuration file would cause traffic disturbance and the node is not accessible from a remote management site.

There are two ways to enter node installation mode:
a. through pressing the BR button after node power-up (Use cases 1 to 3 above). During this period the red and yellow LED on the NPU are on.

b. in case there is no configuration file present at restart.

Node installation mode has priority over NPU installation mode. That is to say that if a condition for node installation mode occurs, even when NPU installation mode was active, the former mode will be entered.

As there are four ways to enter NPU installation mode:
a. Pressing the BR in the installation mode entry interval after NPU power-up (Use case 4). During this period the red and yellow LED on the NPU are on.
b. There is no configuration start-up file present on the NPU (Use case 4).
c. The software on the NPU doesn't match the System Release described in the configuration file and the node fails to upgrade.
d. There is incompatibility between a SR (Software Release) and the Backplane type (Use case 4).

Both installation modes can always be left by pressing the BR. A automatic save of the running configuration to the start-up configuration is always performed.

LCT shall always be directly connected whilst a NPU or a node is in installation mode.

Special behaviour of the node in both installation modes:
The node has a default first IP address.
A DHCP server is running that-provides the LCT with a second IP address.
Default passwords are valid
IP router function is disabled
Operational status of the node shall be set to operational status “reduced service” and node equipment status “installation mode” and the yellow LED on the NPU shall be flashing (1 Hz).
No ‘save’ time-out and manual ‘save’ not possible through the LCT.
IP-address of the FTP as specified in the MIBs is ignored and the second IP address is always used.
FTP user and password are default, i.e. ‘anonymous’.

Each of the 4 use cases that cause the node into installation mode are described in the next sections.

Install Node

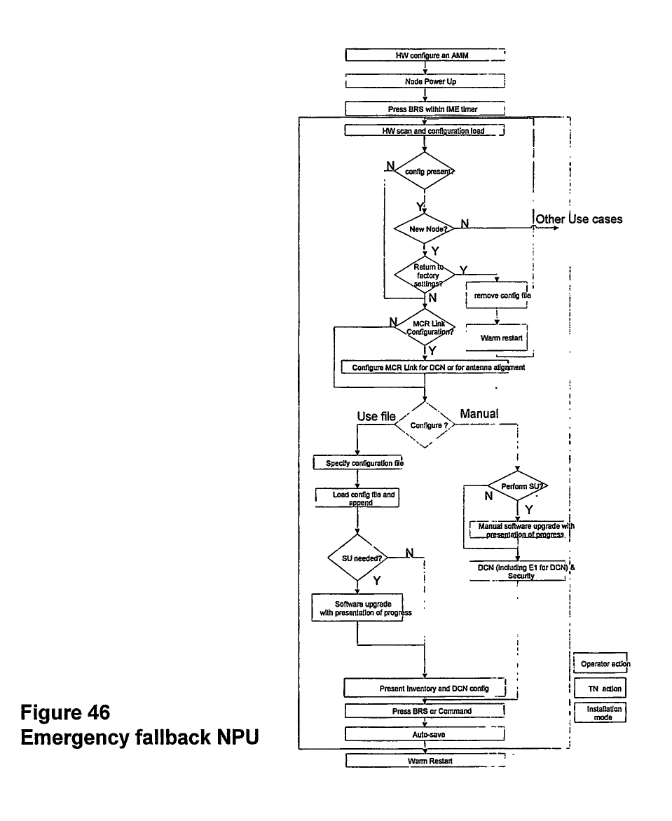

For the installation of a new node the operator arrives with the equipment at the site and has a goal to get the node connected to the DCN after which configuration of the node can be performed remotely as well as locally. The use case is illustrated in FIG. 46.

After the AMM is equipped with the necessary PIUs the operator will turn on the power. In order to enter installation mode he will press the BR as described in the previous section.

Since the configuration stored on the NPU may be unknown the operator is offered to delete the configuration, if one exists and return to factory settings. This means that the operator will have to perform a software upgrade in order to get the SRDF in the node.

In the case where a node is installed traffic disturbance is not an issue. A node power-up followed by an installation mode entry can therefore do a hardware scan to detect all APUs. The NE can then enable MSM/LCT access to the MCR application.

What is important first is to establish DCN connection of the TN NE. The TN NE is connected to the IPv4 based DCN through either PPP links running over PDH/SDH/MCR links or Ethernet. The SDH STM-1 links have a default capacity PPP link on both the RS and the MS layer, no configuration is needed for that. For DCN over E1 and MCR configuration is needed. In the DCN over E1 case a PPP link needs to be set-up over an E1.

For MCR however frequencies have to be configured and antennas need to be aligned on both side of a hop. The latter requires installation personnel to climb in the mast, which due to logistics needs to be performed directly after hardware installation. For the MCR set-up the MSM must be launched. After MCR set-up is performed minimally required DCN, security and Software upgrade set-up can be either configured through the download of a configuration file or manually.

The configuration file indicated in the automatic set-up is appended to the running configuration in order to keep the previous MCR set-up.

In both automatic set-up and manual set-up the operator is informed on the progress of the software upgrade. Complete new NPU PIUs from factory have a configuration file with correct SRDF info present. So here no software upgrade is needed.

After the set-up the inventory data and DCN parameters are shown to the operator, who will exit the installation mode through a command via the LCT or by pressing the BR.

The node will perform a save of the configuration and enter normal operation.

Repair NPU

In case a NPU is defect, the operator can replace the NPU without disturbing traffic, except for traffic on the NPU. For this purpose he has to be on site with a configuration file of the defect NPU. This configuration file can be obtained from a remote FTP server where the node has stored its configuration before. Or he can get it from the defect NPU in case this is still possible.

Since the node will be in installation mode while downloading the configuration file, i.e. has the first IP address, the operator has to move the old configuration file from the directory named by the IP address of the old NPU to the directory named by the first IP address.

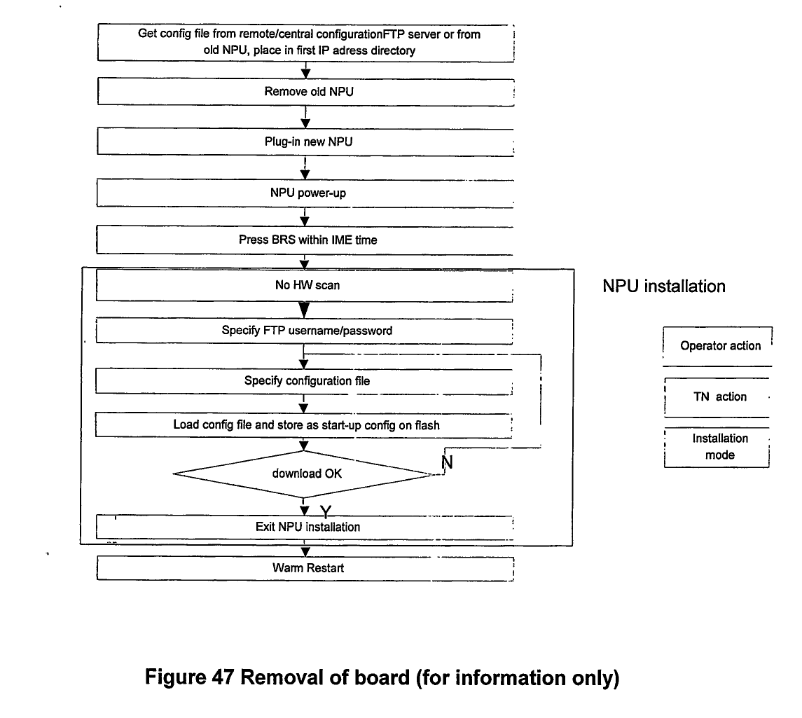

The NPU repair use case is illustrated in FIG. 47. After the old NPU is removed and the new one is plugged in, the operator has to press the BR to enter installation mode.

If he fails to do this the NPU will start-up normally and traffic can be disturbed due to an inconsistent start-up configuration file or in case no configuration file is present the NPU installation mode will be entered. Wrong NPU Software will automatically lead to entering the NPU installation mode.

Since traffic is not to be disturbed the configuration file is not loaded nor is a hardware scan performed.

Since the username and password for the FTP server are set to default the user is asked to enter the username and password he wants to use. This prevents the operator of having to define a new ‘anonymous’ user on the FTP server. After the operator has specified the name of the configuration file the node will fetch the file from the FTP server on the locally connected LCT laptop. The SNMP object xfConfigStatus is used to check if the transfer was successful.

After that the installation mode is left and the node is warm restarted. Upon start-up the node will, if necessary automatically update the software according to the downloaded configuration file.

Change Forgotten Password

If the operator has forgotten the password for a specific node he will have to go to the site and perform a node cold restart, i.e. power-up, and enter installation mode. This will lead to traffic disturbance.

This operation is not possible in NPU installation mode since in NPU repair no hardware scan is performed and saving the running configuration (with the new passwords) would lead to an incomplete start-up configuration file.

The node will perform a hardware scan and load the start-up configuration file. Subsequently the operator can change the passwords and leave installation mode.

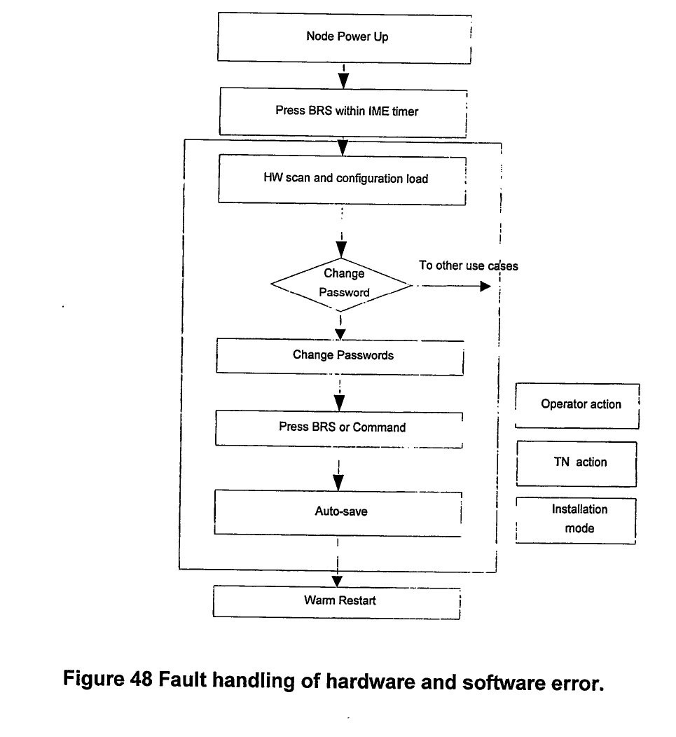

The use case is illustrated in FIG. 48.

Emergency Fallback NPU

This alternative is used when the user wants to force a NPU SW rollback to the previous SW installation. This alternative shall only be used if a SW upgrade has been done to a SW version, which in turn has a fault in the SW upgrade that prevents further upgrades.

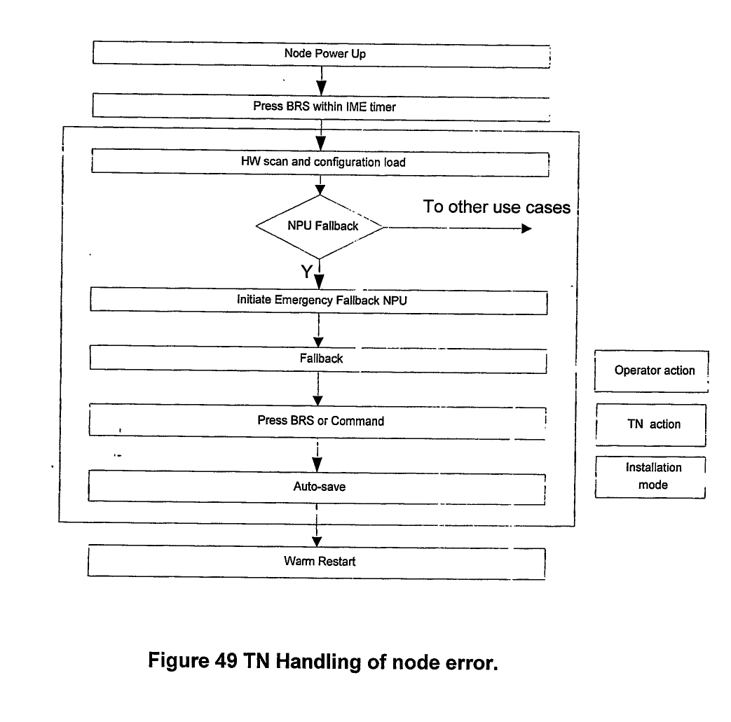

The use case is illustrated in FIG. 49.

Replace a Node

It will be possible to replace a complete node. The configuration file must then be uploaded from the old and placed in the new node.

Hardware of the new node must match the old one exactly. Only APUs placed in the same location will be able to get the previous configuration from the configuration file.

Remove a Board

Note that if the procedure for removing a board is not followed, the node will do a warm restart.

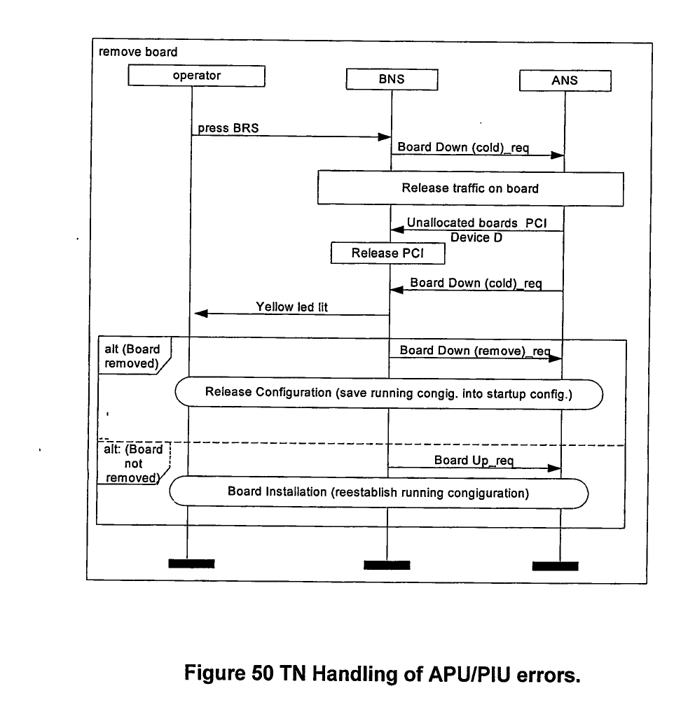

The procedure for board removal is as follows (cf. FIG. 50):

If the board is not removed from the slot within a default period of time after the yellow LED has lit, the remove board request will time out and the board will be activated with the running configuration.

Add Board to Existing Node

The BN will inform the application about the new APUs. The APU shall be given a default configuration.

For a new inserted board notifications are only enabled for board related notifications, not traffic related notifications.

Repair a Board

The node will hold the running configuration for a board for a period τ₆ after this the board has been removed from the slot. This includes that all alarms will stay active until either the board is completely removed or the new board clears the alarms.

The installation personal then have a period τ₆ for exchanging the board with another of the same type.

When the new board is entered the running configuration will be restored to the board. It is also possible that a new ADS will be needed. SW upgrade can then be carried out from a file server or from the LCT.

Repair PFU

Non-Redundant Configuration

In order to handle the case where only one PFU is fitted, and it is to be replaced, a special procedures is implemented.
Press the BR on the PFU.
The NPU notifies the EM and lights the yellow LED.
Remove the power and fan cable.
Replace the PFU.
Re-connect the power and fan cable. The node does a power-up.
   Redundant PFU Configuration

If the node is equipped with redundant PFUs then a PFU repair can be done without taking the node down.

Note: Fan alarms are not suppressed.

Repair Fan

No repair procedure is needed for the fan. The NMS is notified when the fan is removed/inserted.

The replacement of the fan however needs to be quite fast, as the node will otherwise shut down due to excessive temperature.

Reprogram PCI FPGA

The TN NE has been prepared for PCI FPGA reprogramming. The PCI bus has a programming bus associated with it. This bus is a serial bus that may be used by the NPU to reprogram the PCI FPGAs on all the PIUs in the node. This bus is included as an emergency backup if the PCI FPGAs must be corrected after shipment.

Inventory Handling

When a new board is entered into the node, the board shall be activated and brought into service. A notification will be sent to the management system if a new board is detected.

Activation of a board implies:
Activation of DCN channels
Generation of entity MIB's
Software upgrade if needed.
   Management
   Operational Status

Operational status in TN is supported on the node, replaceable units and on interfaces (if Table). This section describes the equipment (node and replaceable units) operational status. An equipment failure is the cause for an update of the operational status. The relation between equipment status severity and operational status is:

| | Equipment alarm |
|---|---|
| Operational status | severity |
| In service | clear/warning |
| Reduced Service | minor/major |
| Out of service | critical |

Operational status (Replaceable unit):

The replaceable units in TN comprises all boards (PIUs) and the fan(s).

In service: This status indicates that the unit is working properly.

Reduced Service This status indicates that normally supported traffic functionality is available but that the management functionality is reduced. (Due to minor alarms like for example high temperature).

Out of service: This indicates that the unit is not in operation, i.e. a traffic disturbing failure has occurred. When a PIU is out of service it is in the cold reset state.

For PFU and FAU this state is not traffic related but indicates either non-presence (administrative state=out of service or a critical defect in the equipment status).

Operational status (Node):

In service: This status indicates that the node is working properly.

Reduced Service This status indicates that the traffic functionality in the backplane is available but that the management functionality (result of a minor equipment alarm) or a redundant function in the node is reduced/unavailable for which a further reduction will have impact on traffic. (result of a major equipment alarm).

Out of service: This indicates that the node is not able perform the traffic function properly.

Equipment Status

Equipment status in TN is supported on the node and replaceable units. This status gives more detailed information as background to the operational status. The status of a replaceable unit is independent of that of the node and vice-versa. A change in the equipment status leads to an update of the operational status and a possible alarm notification with the equipment status as specific problem.

Replaceable Unit

In addition to the operational status, the node supports equipment status on replaceable units. The equipment status may be one or more of the following:

| Equipment | | Operational |
|---|---|---|
| Status | Severity | status |
| In repair | Board | Out of |
| | removed = critical | Service |
| High | High = minor | Reduced |
| temperature | | Service |
| | Excessive = critical | Out of |
| | | Service |
| Hardware | Control = minor | Reduced |
| error | | Service |
| | TDM, Sync | Reduced |
| | bus = major | Service |
| | Power, | Out of |
| | Traffic = critical | Service |
| | For Fan | Out of |
| | fault = critical | Service |
| Wrong | minor/critical | Reduced |
| software | | Service/ |
| | | Out of |
| | | Service |
| Unsupported | critical | Out of |
| unit type | | Service |
| Wrong slot | critical | Out of |
| | | Service |

In addition to the operational status, the node supports equipment status on the node. The equipment status may be one or more the following values:

| Equipment | | Operational |
|---|---|---|
| Status | Severity | status |
| Power | major | Reduced |
| failure | | Service |
| (redun) | | |
| Traffic | 1 TDM/sync | Reduced |
| system | bus | Service |
| failure | fails = major | |
| | 2 or more | Out of |
| | TDM/sync | Service |
| | busses | |
| | fail = critical | |
| Control | Redundant NPU | Reduced |
| system | fails = minor | Service |
| failure | NPU | |
| | fails = major | |
| | PCI failure | |
| | on all boards | |
| | or SPI self- | |
| | test | |
| | failure = major | |
| Installation | Node = minor | Reduced |
| mode | | Service |
| | NPU = major | |
| | (missed | |
| | redundancy | |
| | SNCP) | |

Administrative Status

It shall be possible to set the administrative status of the APUs as follows:

In Service:

Out of service: The APU shall be held in cold reset. Alarms/event notifications are disabled.

When an PIU's administrative state is set ‘out of service’ the operational status will show: ‘out of service’ with no active alarms in the equipment status. This implies that for active alarms a ‘clear’ trap will be sent.

A PFU or FAU that is set to ‘out of service’ is regarded as not present, i.e. no redundancy in case of PFU, and not taken into account for the node operational state. For covering the case where a redundant PFU is wanted but it is detected faulty, i.e. not present. In that case the PFU is shown as administrative status ‘in service’ whilst operational status is out of service. At least one PFU in the node must have administrative status ‘in service’.

Node Configuration Handling

The node stores the configuration in one start-up configuration file. The file consists of ASCII command lines.

Each application has their chapter in the configuration file. The order of the application in the configuration file must represent the protocol layers. (SDH must come before E1 etc). Each application is must specify its order in the start-up configuration file.

The start-up configuration is housed on the NPU, but the node is also able to up/down load start-up configuration from an FTP site.

When the node is configured from the “SNMP/WEB/Telnet” it will enter an un-saved state. Only running configuration is updated, i.e. running is not equal to start-up configuration anymore. Entering this state will start a period τ₆ timer, successive configurations will restart the timer. The running configuration is saved when a save command is received before the timer expires. If the timer expires the node will do a warm restart and revert to the latest start-up configuration.

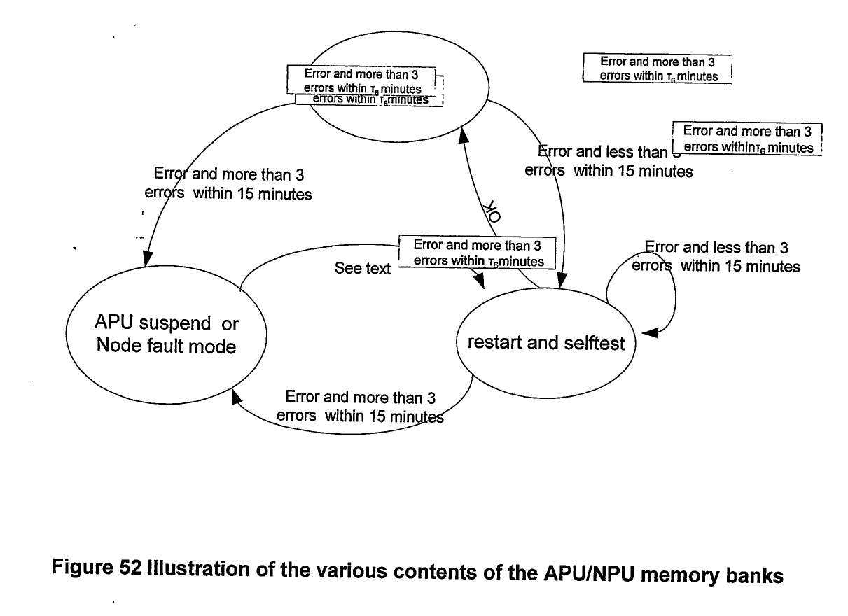

The node is also able to backup the start-up configuration file to an FTP server. This is done for each save command, however not more frequently than a period τ₆. The save command handling is illustrated in FIG. 52.

node generated save-command

The node updates the start-up configuration in the case of board removal (after τ₆ timeout). The node is only updated in case of saved state.

Configuration Validation

The configuration file shall include information about the AMM type for which the configuration is made.

Configuration files should not be exchanged between different backplane type. However in case e.g. an AMM 6p configuration file is used for a AMM 20p a kind of best effort will be done in configuring boards and node.

If the file contains configuration for an empty slot, that part of the configuration shall be discarded.

If the file contains configuration for a slot not matching the actual APU type, that part of the configuration shall be discarded.

Fault Handling (Equipment Error)

General

This section describes equipment errors in the node. The node handles single errors, double error is not handled.

Faults shall be located to replaceable units. Faults that cannot be located to one replaceable unit shall result in a fault indication of all suspect units.

The actions in this chapter are valid for units with administrative status set to ‘In Service’. If a unit has administrative status set to ‘Out of service’ alarms shall be suppressed, and the unit is held in cold reset.

General Fault Handling

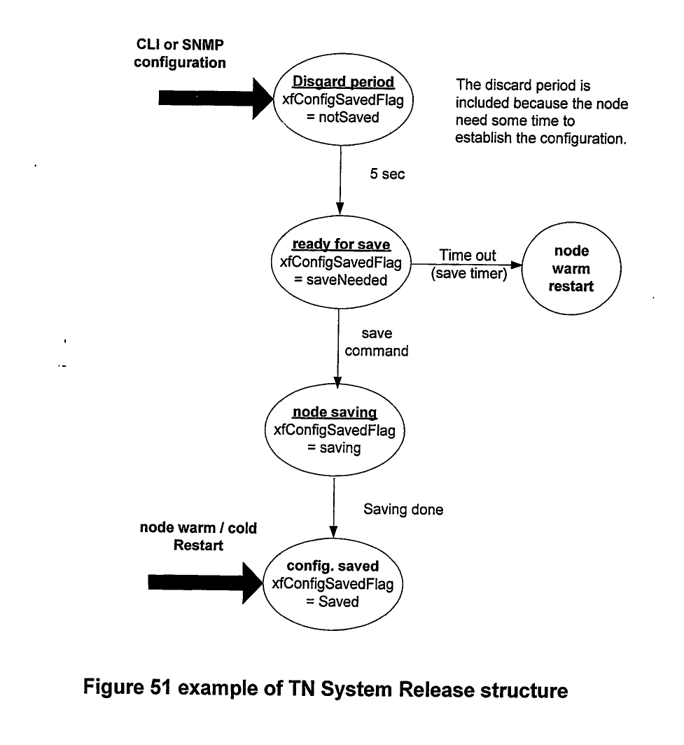

The FIG. 51 shows general principle of TN fault handling of hardware and software errors.

Fault handling includes handling of software and hardware faults. Other faults like temperature violation is not handled according to the state diagram above.

Node Error Handling

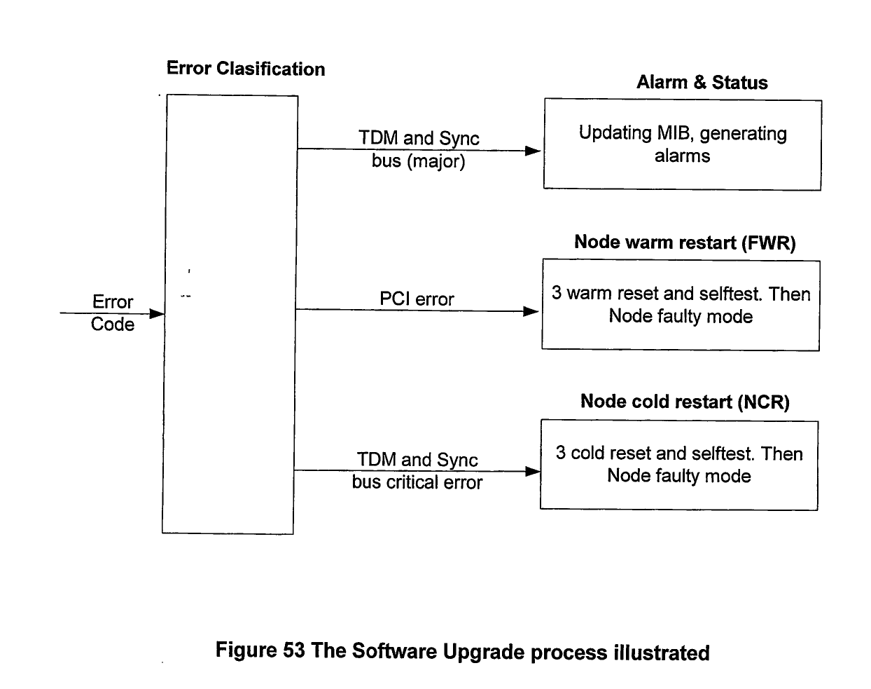

The FIG. 53 shows how the TN handles Node errors.

The Node fault mode is entered after 3 warm/cold fault restart within a period τ₆. In this mode is the NPU isolated from the APUs and fault information can be read on the LCT.

APU Error Handling

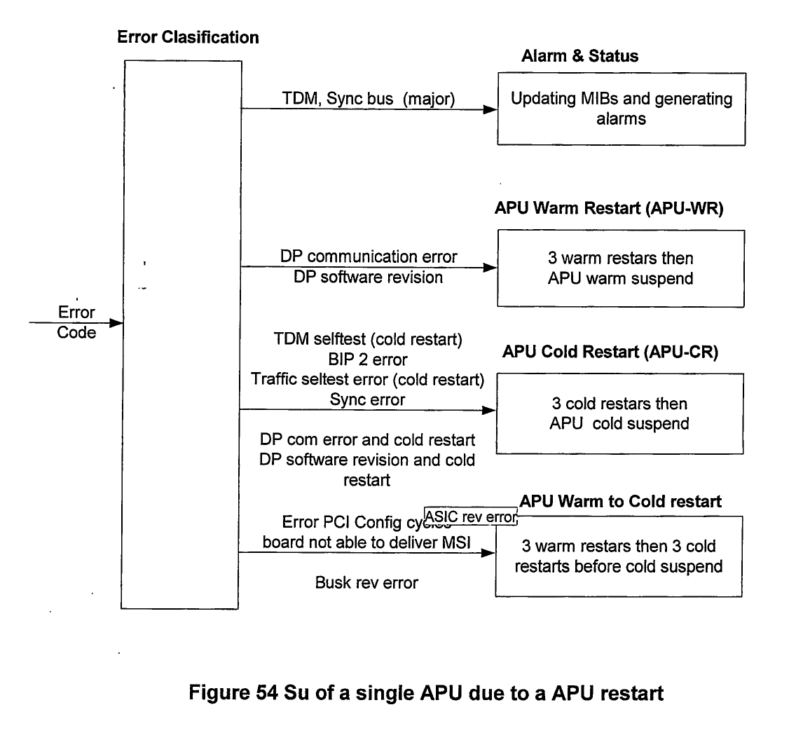

The FIG. 54 shows how the TN handles APU errors.

Board Temperature Supervision

The ANS shall set the temperature tolerance of the board, default 70/75° C. for highexcessive. The BNS shall set the high and excessive temperature threshold as ordered by the ANS. The BNS shall accept and set values in the range 50-95° C. Incorrect values shall result in default values and the operation shall be logged in the sys log.

BNS shall do the equivalent for the NPU and PFU boards.

Detection

Temperature will be measured on all boards in the node. Two levels of alarms shall be supported, excessive and high temperatures. The temperature sensor in the SPI BB will do this.

Notification

The PIU operational status shall be set to: minor/high temperature

critical/high temperature

Depending on which threshold is crossed.

Note that this should not give any visual indications as the fault is likely to be either a fan failure or a rise in the ambient temperature.

Repair

The high temperature threshold crossing shall lead to a power save mode on the APU (set the board in warm reset).

The PIU shall after this be taken in service again if the temperature on the board is below the high temperature threshold continuously for a period of τ₂.

Excessive temperature on the board shall result in a cold reset of the board. This second threshold level shall be handled by hardware and shall not be under software control. Board temperature reduction shall automatically take the boards into service again.

Excessive temperature on the PFU shall shut off power to the node. This function shall be latching, i.e. the power to the node shall be turned off before the power comes on again.

Based on high temperature the node will enter “node fault mode”, Isolated NPU, no access to other board. The mode will be released when the high temperature indication is removed.

Fan Supervision

Detection

The fan status is signalled on the SPI bus from the PFU. The signals only indicate OK/NOK. The individual fans are supervised and a failure is indicated if one fan fails.

A fan cable removal shall be detected as a fan failure.

Identification

SPI signal.

Notification

The fan operational status shall be set to: critical/hw error.

Notification/Alarm to NMS

The fault LED on the fan shall be lit.

Repair

Manual replacement.

The fault may in addition result in temperature supervision handling.

Board Type not Supported

Detection

The SPI indicates that the NPU SW does not support a board type.

Identification

The SPI inventory information displays a board not supported by the NP SW.

Notification

The APU operational status shall be set to: critical/unsupported type.

The APU fault LED shall be lit.

Notification will be sent to the NMS.

Repair

None, the board will be held in cold reset.

APU-Power

Detection

The basic node shall supervise that the APUs has a correct local power. This is supervised through the use of local power sensors. A power sensor fault will normally indicate that the APU has had a power dip.

Identification

SPI signal.

Notification

The power LED shall be turned off and if possible the fault LED shall be turned of during the time that the power is faulty.

The APU operational status shall be set to: critical/hw error

The error will be reported to the application, and then to the EEM

Repair

The board will be held in cold reset to power is back.

PFU/Input Power Supervision

Detection

The PFU will detect loss of incoming power or PFU defect with loss of incoming power as a consequence. This can of course only be detected when redundant power is used.

Identification

The PFU geographical address.

Notification

The NE operational status shall be set to: major/power failure

The PFU operational status shall be set to: critical/hardware error Alarm will be sent to the EEM.

Fault LED on PFU on and power LED on PFU off while the power is faulty.

Repair

None

LED Indications

The following LED indications shall be given on the PIUs:

| | Green | Red | Yellow | |
|---|---|---|---|---|
| Unit | LED | LED | LED | Description/state |
| All | ● | — | — | Power OK |
| All | — | ● | — | Faulty unit, wrong slot, |
| | | | | unsupported board. |
| All | — | — | ● | Board may be removed |
| except | | | | (board removal interval) |
| FAU | | | | The FAU doesn't have |
| | | | | yellow LED |
| PFU | ◯ | ● | — | Power delivery failure |
| | | | | red. pwr. |
| | ◯ | ◯ | | unconnected power |
| | | | | cable |
| | | | | PFU failure (fuse, |
| | | | | SCP . . . ) |
| | ◯ | ◯ | — | Power delivery failure |
| | | | | no red. pwr. |
| | | | | unconnected power |
| | | | | cable |
| | | | | PFU failure (fuse, |
| | | | | SCP . . . ) |
| All | ● | ◯ | ◯ | Power up |
| except | | | | |
| NPU | | | | |
| NPU | ● | ● | ● | NPU power up (IME |
| | | | | interval) |
| | ● | ● | ◯ | NPU restart - during |
| | | | | self-test |
| | ● | — | [symbol] | Node/NPU in installation |
| | | | | mode |
| | — | [symbol] | — | TN NE failure (busses) |
| | | | | Node fault mode. |
| | ● | ◯ | ● | NPU BR |

● LED turned on [symbol]
LED flashing 0.5 sec frequency
◯ LED turned off
— Unchanged

If BR Button is pressed on a faulty NPU the red led will be turned off during the BPI, this to avoid conflict with the NPU power up signal.

Tn, Software Upgrade

Scope

This section describes the software upgrade functionality offered by the TN. It specifies the functionality for upgrading one TN, not the functionality offered by external management to upgrade a whole network, like how to upgrade from network extremities back to the BSC or how to upgrade several TNs in parallel.

General

Software Upgrade is the common name for Remote Software Upgrade (RSU) and Local Software Upgrade (LSU). Where RSU is defined as software upgraded from a remote FTP server whilst for LSU the local PC is used as FTP server.

Software present on a TN is always according to a defined System Release (SR). A SR is a package of all software that can be replaced by a SU of the software for:
TN Basic Node Software (BNS) in the NPS load module
Application Node Software (ANS) in the NPS load module
Application DP Software (ADS), i.e. APU with DPs

The TN uses FTP for both RSU and LSU.

A TN is always upgraded to a SR. A SR contains always all BNS, ANS and ADS for that specific release. When performing a RSU or LSU, it is always from one SR to another.

FTP Server

Software is transferred to the TN using the FTP both for RSU as well as LSU. BNS has an FTP client that can download files from an FTP server.

The server is either on the DCN or in a locally attached PC, there is no difference between RSU and LSU except for speed.

For RSU there must be an FTP-server somewhere on the DCN. Considerations must be taken to the DCN topology to avoid the RSU taking too long. Even if the network is okay from a traffic point of view, this might not be the case in the DCN point of view. There can be a need of several ftp-servers on the same DCN. The files to be downloaded to the TN then have to be pre-loaded to the local ftp-servers.

For LSU an FTP server has to be installed on the LCT PC.

System Release Structure

A TN System Release (SR) consists of load modules for each type of processor software in the TN, and a System Release File (SRDF) describing the contents of the SR.

The SR must be backward compatible at least two major customer releases. That is a release “n+3” is at least backward compatible with release “n+1” and “n+2”. This to limit testing of software upgrade/downgrade, e.g. when R6 is released it will have tested against R4 and R5.

It shall be possible to have different SRs running on different TNs within one TN network.

The System Release Description File

As the SRDF file name and ftp-server location are given as MO's, see XF-SOFTWARE-MIB. Nodes can be given different SRDF files and thereby run different Software, i.e. contain different load modules.

SRDF is a CLI script file that is transcribed into the XF-SOFTWARE-MIB when downloaded and thus read-only. It is the only way to get information about load modules to the TN. The syntax and semantics of the SRDF shall be revision controlled. It shall be possible to add comments to the SRDF. This can for example be used to indicate the APUs a certain DP software module belongs to.

Each TN System Release will be represented by a directory on the ftp-server named by the product number and version of that release and contained by a tn_system_release directory. All load modules plus a srdf.tn file reside within one System Release directory. Product number and revision will denote each individual load module. For example:

| | |
|---|---|
| tn_system_release/ | |
| <name_of_release> directory | |
| srdf.tn | SRDF-file |
| CXP901584_1_R1A | NPU load module file |
| CXCR102004_1_R1B | LTU 155 load module |
| file | |
| <number_MMU>_R2A | load module file |
| <number_MMU_RAU>_R1A | load module file |

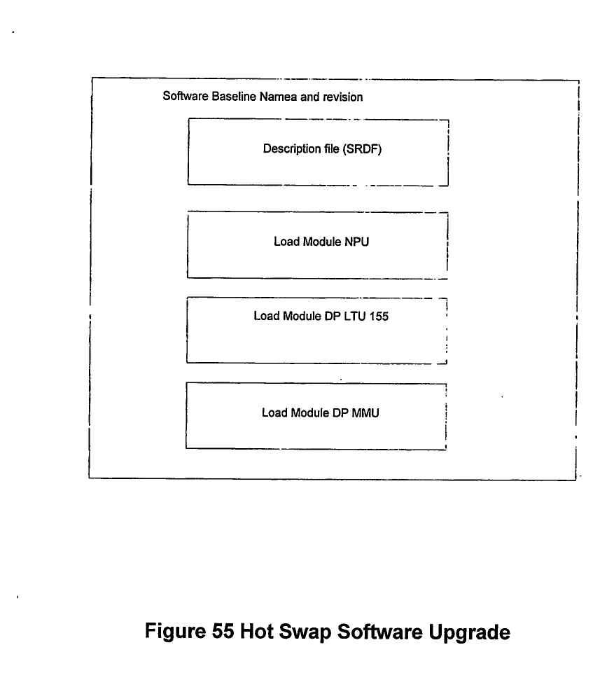

FIG. 55 shows an example of TN System Release structure. An optional header can include e.g. revision, hardware-version, and checksums, to enable BNS to control that it is the correct load module that has been loaded. Some of this information shall be included in the SRDF file as well.

The TN Basic Node shall provide a RAM-disk of 6 MBytes for software upgrade of DP's.

The XF-SOFTWARE-MIB

All control and information regarding software upgrade will be represented by Managed Objects in the XF-SOFTWARE-MIB.

For each TN two System Releases will be defined in the XF-SOFTWARE-MIB, one Active System Release and one Passive System Release. For each System Release the overall product number and revision is presented in the XF-SOFTWARE-MIB as well as the product number and revision of each load module contained by the corresponding System Release.

The active SR shows the current SR running on the TN and is a reference for new boards as to what software should run on the board in order to be compatible with the rest of the node.

The passive SR describes the previous SR the node was upgraded to whilst in normal operation. During the software upgrade process the passive SR will describe the software the TN is currently upgraded to.

The XF-SOFTWARE-MIB Software shows the product number and revision of current running software in the active memory bank for each APU and those for the software in both active and passive of the NPU

The Software Memory Banks

Each APU/NPU with a DP contains two flash memory banks, an active and a passive one. The flashes are used to contain the current and previous software for the corresponding APU/NPU. The software in the active bank is the one running. The one in the passive bank is used to perform a fallback to a previous System Release for that APU/NPU whilst a new software upgrade is being tested.

The software in the passive bank can also be used to perform a manual switch to previous software for the NPU. This is not a normal situation procedure and can only be performed in installation mode. It should only be used in emergencies and is against the policy that a node only runs a tested SR.

The software modules described in the active SR will always be present in the active memory bank of the respective NPU or APUs.

The passive memory bank can contain the following software:

1) The load module as described in passive SR. In this case the load module in the passive SR is different than the one in the active SR. In case of a fallback the APU/NPU will switch to the passive memory bank if it is a part of the passive SR.

2) The load module does not correspond with either active nor passive release in case:

a) The load module had the same release in the last two upgrades. In this case a fallback will not lead to a memory bank switch.

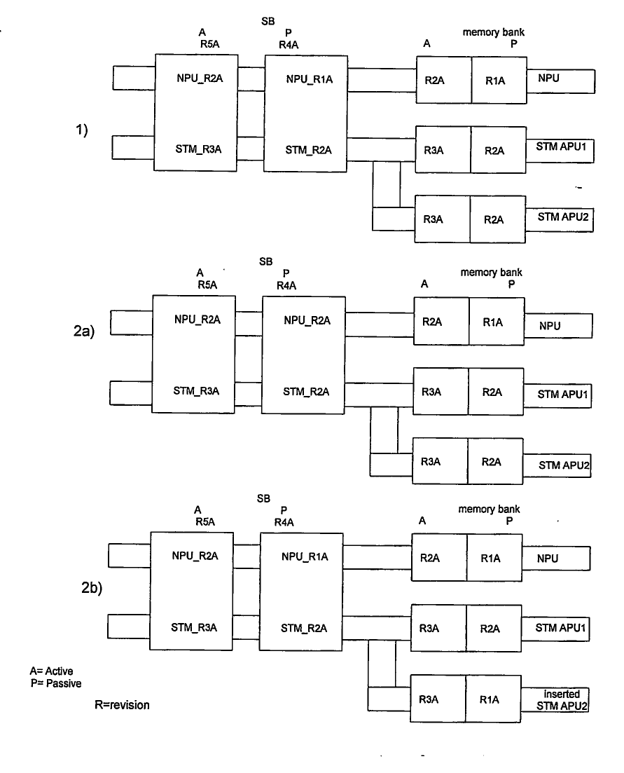

b) The APU was inserted into the system after a software upgrade of the TN as a whole. In this case, automatic software upgrade of this single APU is performed as described in the section describing “Software upgrade of single APUs—Normal procedure”. In this case fallback is not an option as will be explained in the following section “Fallback”. Illustrations of the various contents of the APU/NPU memory banks is shown in FIG. 56.

Upgrade of a Node to a System Release

Normal Procedure

The main software upgrade sequence is the one performed remote or local, i.e. from an EM or EEM, for a whole node. Special cases are described in the following sections.

Before starting a software upgrade the FTP server location (IP address) and username/password must be specified.

The software upgrade sequence is started with the EM/LCT changing objects in the TN describing the product number and revision of the SR to upgrade to. Once the EM/EEM starts the upgrade process the TN will ask for the SRDF-file via its FTP client on location:

The tn_system_release is the directory under which all SRs for TN are available. This is not configurable by the EM/LCT:

When the SRDF-file has been downloaded, evaluated and represented in the XF-SOFTWARE-MIB, the TN will download the necessary load modules via its FTP client to its RAM-Disk.

For the software upgrade process to proceed fast enough, the FTP server is assumed to have a limited number of client connections open at a given time. So in case of an upgrade of a whole network, few high-speed connections are preferred over many low-speed connections.

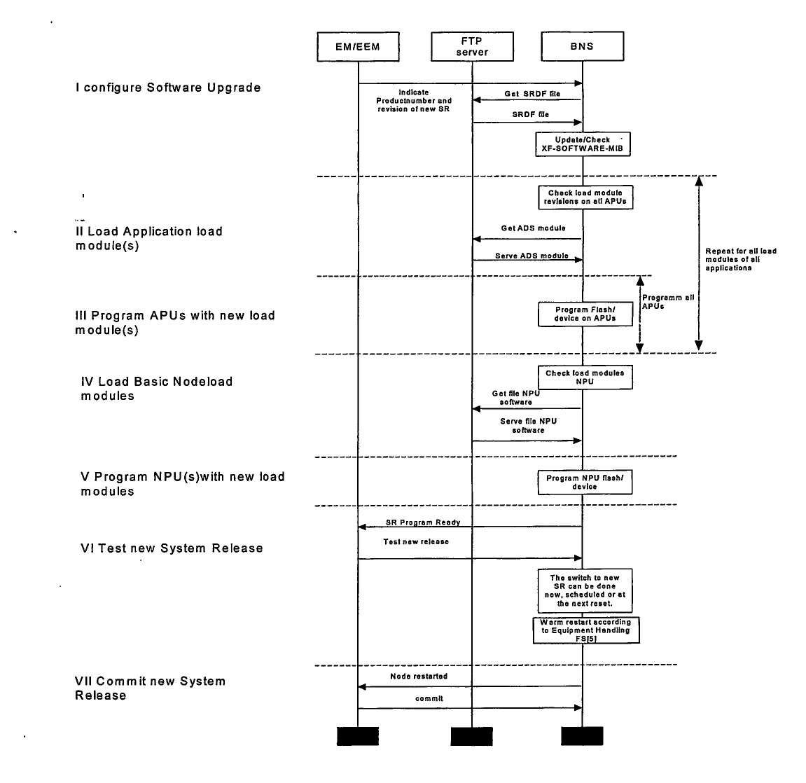

The whole process is illustrated in FIG. 57.

A load module downloaded to the RAM-disk on the NPU must be marked read-only until the respective controlling program, i.e. ANS, has finished the download to the target FLASH.

The new software is now marked to be used after a warm-restart of the TN and the EM/LCT orders a warm-restart directly or scheduled at a given date and time.

The warm-restart at a specified date and time will be used if many nodes are upgraded and have to be restarted at approximate the same time to have the OSPF routing tables update as soon as possible.

Marking the new version for switching will happen at the given date and time just before the warm-restart.

During the warm-restart of the TN all ANS will check their APU's (by self-tests) to see whether the correct ADS is running. APUs that are in cold reset are not tested in the test run. If all was OK, the EM/EEM-user will be notified about this. The EM/EEM-user shall then have to commit, within a certain time, the new System Release. If no commit is received by the TN in time a fallback will be performed, i.e. it will mark the old revision as active and perform a warm-restart again.

The operator can also indicate a so-called node initiated commit. In that case the operator doesn't have to commit the new software, but the node checks whether it still has DCN connectivity. In case DCN connectivity was lost as a result of the software upgrade a fall-back will be performed.

A node initiated commit will be default when executing a scheduled SU.

The progress of the LSU/RSU process shall be available through status MO's in the XF-SOFTWARE-MIB.

Failure of Upgrade of APUs as Part of a System Release

In order to have a consistent and tested SR running on the TN APUs that fail to upgrade as part of a SR upgrade will be placed in warm reset in test phase and after a commit.

This means that traffic will be undisturbed but that the APU is not longer under control of the NP software.

Another attempt to upgrade the board will be made when the APU or TN is warm/cold restarted.

Hot Swap During Upgrade

A board inserted during the software upgrade process will be checked/upgraded according to the active SR. It will not be upgraded as part of the upgrade to the new System release but as part of the test phase of the new system release.

No Load Module for APU

If no load module is present in the new SR for an APU type, these APUs will be set in warm reset and upgrade to the new SR will continue?

Equipment Error During Software Upgrade

Any form for equipment error during software upgrade will lead to abortion of the software upgrade process, which will be notified to the EM/LCT-user.

If an APU is in the cold/warm reset state due to e.g. “hardware error”, “administrative state down” or “excessive temperature” it shall still be possible to perform a software upgrade of a SR. The specific board will not be upgraded. But the software upgrade will fail if the equipment status on an APU changes during the upgrade.

SR Download Failures

The following failures can occur during download of SRDF and load modules for a SR:

FTP server/DCN down; the access to the FTP client times out

Wrong username/password

Requested directory/file not found on FTP server

Corrupted load module

All these cases 3 attempts will be undertaken. Failure after 3 attempts leads to abortion of the software upgrade (in case of SRDF) or placing the corresponding APUs in warm reset as stated in the section above; “Failure of upgrade of APU's as part of a system release”.

Fallback

After a switch to the new SR, i.e. an TN warm-restart, the TN goes into a test phase. The test phase will end when the COMMIT order is received from external management. After the COMMIT order is received, there will be no fallback possible. Situations that will initiate a fallback are:
COMMIT order not received, within a period 16 after the switch
Warm/cold node restart during the test phase.

If one of the situations mentioned above occurs, then the NPU will switch SR (fallback). Then the APUs will be ordered to switch software according to the previous SR. Manual/ forced fallback is not supported in the TN.

SU not Finished Before Scheduled Time

In case the downloading of all required load modules is not finished a period of τ₇ (typical 5 minutes) before the scheduled time, the whole SU will be aborted and the operator will be notified.

Software Upgrade of Single APUs

Normal Procedure

In order to have a consistent SR running on the TN APUs that are restarted have to have the correct software in respect to the SR. A restart of a APU can be caused by:
The operator who initiates a cold restart of the APU
An APU being inserted
A cold/warm restart of the node. Only APUs in warm reset will then be restarted.

The principle of ‘plug and play’ shall apply in these cases, which means that the restarted APU shall be automatically upgraded:

Check out whether the software revision according to the active SR is already on the APU (passive or active memory bank).

If not, download the corresponding load module and then switch software on that board.

The board will then run software according to the active SR, but the software in the passive memory bank might not be according to the passive SR.

BNS does not update both banks. Manual/ forced fallback is not supported in TN.

When no boards are inserted since last software upgrade a fallback of the whole node could be achieved by downgrading the software. In that case only the SRDF has to be downloaded, since the previous software is still in the passive memory banks.

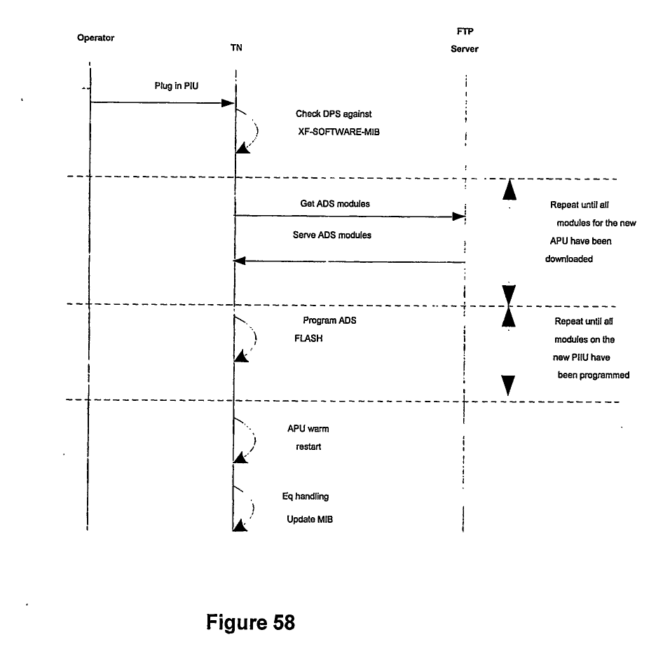

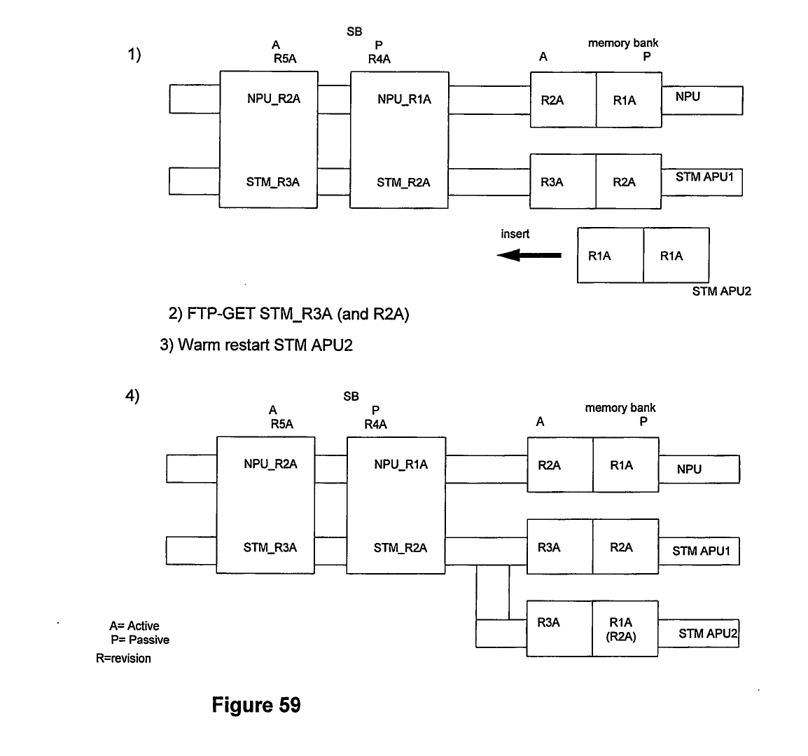

The ANS shall be able to communicate with older ADS when it comes to SU. FIG. 58 shows software upgrade of a single APU due to an APU restart and FIG. 59 discloses a hot swap software upgrade.

New Board Type Inserted

In case a new board type is inserted wherein a ANS on the NPU is missing, the APU will be marked not-supported and placed in cold reset.

Failure of upgrade of APUs

In case SU for a single cold restarted APU fails, three attempts will be made before the APU will be placed in cold reset.

In case SU for a single warm restarted APU fails, three attempts will be made before the APU will be placed in warm reset.

Load Module Download Failures

The following failures can occur during download of a load module for a DP:
FTP server/DCN down; the access to the FTP client times out
Wrong username/password
Requested directory/file not found on FTP server
Corrupted load module

For all these cases section “Failure of upgrade of APUs” applies.

New System Release Already in Passive Memory Bank

In case the new DP is already in the passive memory bank of the. Then there is no need for downloading the load modules for that APU.

Load Module not Specified

If a load module is not specified in the SRDF, there can be no upgrade of that APU. The APU will be placed in cold reset.

Fault During Flash Memory Programming

If an error occurs in the process of programming the flash the TN will be notified and the whole upgrade process is aborted. The equipment status (hardware status) of the faulty board will be set to hardware error (critical), i.e. Out of Service, this will light the red led on the APU. The ANS must handle Flash located on the APU.

Special NPU Cases

Upgrade of Non-TN Boards

If the NPU software does not handle the upgrade, e.g. in the MCR Link1 case, the NPU software will only be aware of the hardware through the equipment handling of the board.

No SRDF Available

When no SR information in the configuration file is present on the NPU the node will enter NPU installation mode upon restart.

Incompatible Software and AMM

In case the active software is incompatible with the AMM or doesn't recognize the AMM, the node will go in NPU installation mode upon restart.

Requirements to the Configuration File

The SU configuration command saved in the configuration file must be backward compatible.

Upgrade Time

In this section an estimate is made for both LSU and RSU.

RSU

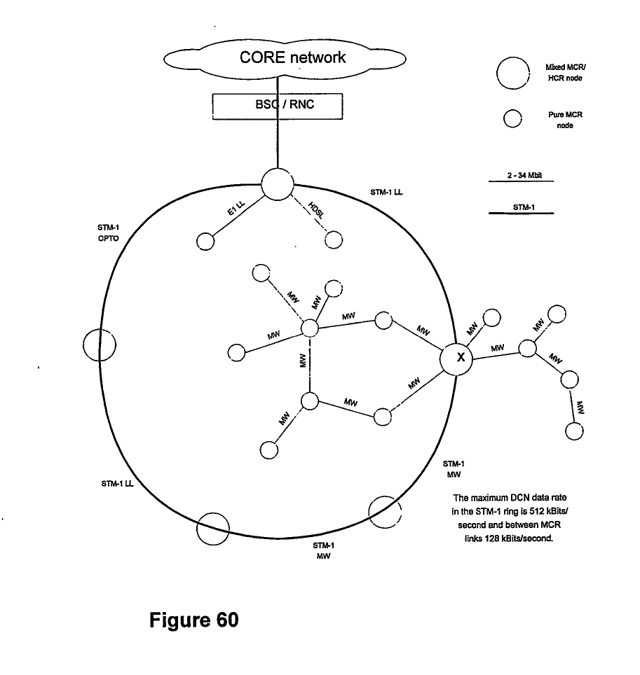

In order to estimate the total RSU time for a reference TN network topology and a structure as shown in FIG. 60 the following characteristics are assumed:
16 Mbytes in a SR
512 kBits/s DCN in the SDH ring
128 kBits/s DCN on the radio links
no IP congestion and overhead
5 TNs in the STM-1 ring
four MCR sub-branches per TN in the STM-1 ring
a depth of MCR sub-branch of 3

A typical RSU time can be calculated. It will take 16*8 [Mbit]/0,512 [Mbit/s]=250 seconds in the STM-1 ring per TN and 16*8 [Mbit]/0,128 [Mbit/s]=1000 seconds in the MCR branch.

A MCR branch can have four (512/128) sub-branches without adding to the download time, i.e. software to a TN in each of the branches can be performed in parallel.

In the MCR branch, however, downloads must be serialised at 128 Kbits/second.

For a reference network with 5 TN in the STM-1 ring and four MCR sub-branches with a depth of three, i.e. a TN sub-network of 60 NEs, the download time is:

5[SDH NE]*250[sec/SDH NE]+5 [SDH NE]*3[TN/Branch]*1000[sec]=16250 sec=4.5 hours

Each SDH NE plus its 4 branch, depth 3 sub-network RSU will require 3250 seconds, about one hour, longer.

Every 4 extra branches for a SDH NE will require 1000 seconds per TN in a branch. Say roughly one hour, assuming a depth of 3 to 4, per 14 TNs.

The actual erasing/programming of the flash memories adds to these times. Estimated programming times of flash are 14 seconds/Mbytes to erase and 6 seconds/Mbytes to program. This adds to 320 seconds for 16 Mbyte.

However one cannot just add the download time and flash programming time, because a smart system will probably use the erase time on a node to download etc.

A typical requirement for a maximum time for a commercial system may typically be 8 hours, which is fulfilled for the assumed reference network when programming and downloading are two parallel processes. However an extra hour is required for each new branch, of depth 3 to 4. Which means that requirements will be fulfilled for TN sub-networks with up to

8 hrs=28800 sec/(3250 sec/(1+3*4)NEs=115 TNs.

The maximum time for RSU of a TN from EM is τ₈ (typical 30 minutes).

Typical values of the timing parameters (τₙ)
τ₁: 1 second
τ₂: 60 seconds
τ₃: 30 seconds
τ₄: 50 mseconds
τ₅: 2 seconds
τ₆: 15 minutes
τ₇: 5 minutes
τ₈: 30 minutes
   Terminology
   (Sorted by Subject)
   Application:

Board specific SW and hardware (SDH-TM is an application)

High Availability:

Notation from cPCI standards characterising the ambition level of the system with respect to availability. In this document it mainly refers to the module in the basic node which is responsible for SW supervision and PCI config.

Platform:

Basic Node.

Fault Detection:

The process of detecting that a part of the system has failed.

Fault Identification:

The process of identifying which replaceable unit that has failed.

Fault Notification:

The process of notifying the operator of the fault.

Fault Repair:

The process of taking corrective action as a response to a fault.

Warm Reset:

This is a signal on all boards. When pulsed it takes the board through a warm reset (reset of the control and management logic). While asserted the unit is in warm reset state. The PCI FPGA will be reloaded during warm reset.

Cold Reset:

This is a signal on all boards. When pulsed it takes the board through a cold reset (reset of all logic on the board). While asserted the unit is in cold reset state. The cold reset can be monitored.

Warm Restarts

A restart of the control and management system. Traffic is not disturbed by this restart. The type of restart defines the scope of the restart, but it is always limited to the control and management parts. During the restart the hardware within the scope of the restart will be tested.

Cold Restart:

A restart of the control and management—and the traffic—system This type of restart will disable all traffic within the scope of the restart. The type of restart defines the scope of the restart. During the restart the hardware within the scope of the restart will be tested.
Temperature Definitions: 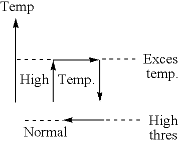
High Temperature Threshold:

The threshold indicates when the thermal shutdown should start. The crossing of the threshold will give an SPI interrupt to the NPU.

Excessive Temperature Threshold:

The threshold indicates when critical temperature of the board has been reached. The crossing of the threshold will give a cold reset by HW and an SPI status indication to the NPU.

Excessive Temperature Supervision Hysteresis:

The high and excessive temp thresholds determine this hysteresis. If the excessive temp threshold is crossed then the cold reset will not be turned off until the temp is below the high temperature threshold.

High Temperature Supervision “Hysteresis”:

The high temperature supervision will make sure that the board has been in the normal temperature area continuously for at least a period τ₂ before the warm reset is turned off.

Normal Temperature:

In this area the boards are in normal operation.

High Temperature:

In this area the boards are held in warm reset. This is done in order to protect the system from damage. The shutdown also serves as a means for graceful degradation as the NP will deallocate the PCI resources and place the APU in warm reset thus avoiding any problem associated with an abrupt shutdown of the PCI bus.

Excessive Temperature:

In this area the boards are held in cold reset. The SPI block (HW only) does this when the excessive temperature threshold is crossed. This is done in order to protect the system from damage.

Running Configuration:

This is the active configuration of the TN node. See the section Node Configuration Handling for more details.

Start-Up Configuration:

This is a configuration of the TN node saved into non-volatile memory, the running configuration is stored into the start-up configuration with the save command. Node and NPU restarts will revert from running to start-up configuration.

Administrative Status:

This is used by the management system to set the desired states of the PIUs. It is a set of commands that sets the equipment in defined states.

Operational Status:

This information describes the status of the equipment. Management can read this. Operational status is split into status and the cause of the status.

Board Removal Button (Br):

This is a switch located on the front of all boards. If it is pressed this is a request to take the board out of service (see service LED). On The NPU this switch is used to place the node and the NPU in installation mode.

Service LED:

This is a yellow LED indicating that the board can be taken out of the sub rack without disturbing the node. The service LED on the NPU will also be lit during the period after a node or NPU power-up in which the board may be placed in installation mode. When the node is in installation mode the yellow LED on the NPU will flash. The term yellow LED and service LED is in this document equivalent.

Power LED:

This is a green LED indicating that the board is correctly powered. The term green LED and power LED is in this document equivalent.

Fault LED:

This is a red LED indicating that a replaceable unit needs repair handling. The NPU fault LED will be on during NPU restarts until the NPU self-test has completed without faults. The APU will have fault LED default off. The NPU fault LED will flash to indicate node/bus faults. The term red LED and fault LED are in this document equivalent.

Node Installation Mode:

This is a state where the TN may be given some basic parameters. The mode is used to enable access during installation or after failures.

NPU Installation Mode:

This is a mode for repair of the NPU. The mode is used when a new NPU is installed in an existing node.

Node Fault Mode:

The Node fault mode is entered after 3 warm/cold fault restart within a period of τ₆. In this mode is the NPU isolated from the APUs and fault information can be read on the LCT.

Board Repair Interval (BRP Interval)

This is the interval during which an APU and PFU may be replaced with an automatic inheritance of the configuration of the previous APU.

Board Repair Timer (BRP Timer)

This timer defines the board repair interval. It has the value τ₆.

Board Removal Interval (BRM Interval)

This is the interval during which an APU may safely be removed from the sub rack. A yellow LED on the PIU front indicates the interval.

Board Removal Timer (BRM Timer)

This timer defines the board removal interval. It has the value 12.

Save Interval

This is the interval after a configuration command to the NE in which the operator must perform a save command.

Save Timer

This timer defines the save interval. It has the value 16.

Installation Mode Entry Interval (IME Interval)

This is the interval after a node or NPU power-up in which the node may be placed in installation mode.

Installation Mode Entry Timer (IME Timer)

This timer defines the Installation mode entry interval. The specific value of this timer will not be exact but it shall be minimum of T₃ (depends on boot time).

Abbreviations

ADD Application Device Driver
ADS Application Device Processor SW
AIM Application Interface Module, (Part of the ANS that handles the application functionality
AMM Application Module Magazine
ANS Application NPU SW=AIM+ADD.
APU Application Plug-in Unit
ASH Application Specific Hardware
ASIC Application Specific Integrated Circuit.
AWEB Application WEB
BB Building Block
BERT Bit Error Rate Test(er).
BGP Border Gateway Protocol
BPI Board Pair Interconnect
BR Board Removal
BRM Board ReMoval
BRP Board RePair
CLI Command Line Interface
cPCI Compact PCI
DCN Data Communication Network
DHCP Dynamic Host Configuration Protocol
DP Device Processor
E1 2 Mbit/s PDH
EEM Embedded Element Manager
EM Element Manager
FCC Federal Communications Commission
FD Functional Description
FM Fault Management
FPGA Field programmable gates array.
FTP File transfer Protocol
GA Geographical Address
GNU Unix-like operating system
GPL GNU Public Libraries
HCS High Capacity Switch
HDSL High-speed Digital Subscriber Line
HRAN Higher part of Radio Access Network
HSU High capacity Switch Unit
HTML Hyper-Text Markup Language
HTTP Hyper-Text Transfer Protocol
HTTPS HTTP Secure
HW Hardware
I/O Input/Output
IEC International Electrotechnical Commission
IME Installation Mode Entry
IP Internet Protocol
IWD InterWorking Description
JTAG Joint Test Action Group
LAN Local Area Network
LCT Local Craft Terminal
LIU Line Interface Unit
LRAN Lower part of Radio Access Network
LSU Local SW Upgrade
LTU APU hosting 16 E1s
16×2
MCR Medium Capacity Radio
MIB Management Information Base
   Element Manager for the TRAFFIC NODE product family.
Manager
TN TN Network Element
TN BN TN-Basic Node
TN BNH TN-Basic Node Hardware
TN BNS TN-Basic Node Software
TN NE TN Net Element (TN Node)
TN-EM TN Element Manager—see Manager.
MSM TRAFFIC NODE Service Manger
MSP Multiplexer Section Protection
NEM Network Element Manager
NETMAN TRAFFIC NODE Management System
NP Node Processor (the processor on the NPU)
NPS Mode Processor Software
NPU Node Processor Unit
NPU Node Processor Unit (the PBA)
NTP Network Time Protocol
O&M Operations and Maintenance
OSPF Open Shortest Path First
P-BIST Production Built In Self-test
PCI Peripheral Component Interconnect
PCI-SIG Peripheral Component Interconnect Special Interest
Group
PDH Plesio-synchronous Digital Hierarchy
PFU Power Filter Unit
PFU Power Filter Unit
PHP PHP Hypertext Pre-processor
PICMG PCI Industrial Computer Manufacturers Group
PID Process Identification
PIU Plug-In Unit
PM Performance Management
PPP Point-to-Point Protocol
PRBS Pseudo-Random Binary Signal
PtP Point to Point links connecting APU and HSU slots
RAM Random Access Memory
RSU Remote SW Upgrade
SCP Short Circuit Protection
SDH Synchronous Digital Hierarchy
SDH TM SDH Terminal Multiplexer
SDRAM Synchronous Dynamic Random Access Memory
SNCP Sub-Network Connection Protection
SNMP Simple Network Management Protocol
SPI Serial Peripheral Interface. A synchronous serial bus.
SRDF System Release Description File
SSL Secure Socket Layer
STM-1 Synchronous Transport Module-1
SW Software
TCP Transport Control Protocol
TDM Time Division Multiplexing
UDP User Datagram Protocol
URL Uniform Resource Locator
XF-EM XF-Element Manager and LCT
XF-NE XF Node same as ML-TN

1. A telecommunication or data communication node comprising a number of plug-in units, a first number of the plug-in units hosting a device processor, the first number of the plug-in units comprising a first and a second flash memory bank, and the node further comprises a separate traffic and control system, characterised in that one of the memory banks is adapted to be in an upgradeable state and the other memory bank is adapted to be in a operable state, where the states are mutually interchangeable, the node comprising redundant traffic buses and the traffic and control system being separated on intra boards and inter boards respectively.

2. (canceled)

3. System according to claim 1, characterised in that the traffic buses are Time Division Multiplex, TDM, buses having redundant switching functions, the Plesi-synchronous Digital Hierarchy, PDH, and Synchronous Digital Hierarchy, SDH, synchronisation buses are redundant and the fan systems are redundant.

4. System according to claim 1, characterised in that said telecommunication or data communication node's software consists of the following major component types:
a. basic node software, BNS, that realises the control and management of said node and its Traffic Node Basic Node Hardware Building Blocks, TN BNH BB, residing on Application Plug-in Units, APU's,
b. application node processor software, ANS, which is a control software for the application and for all software on a Node Processor Unit, NPU,
c. application device processor software is located on the APU, provided that the APU houses one or more processors, it interfaces with ANS.

5. (canceled)

6-22. (canceled)

23. System according to claim 1, characterised in that said telecommunication or data communication node comprises a plurality of distributed power sensors sensing a voltage level on said plug-in units and said boards.

24. A method within telecommunication or data communication node where the telecommunication or data communication node comprises a number of plug-in units, a first number of the plug-in units hosting a device processor, the first number of the plug-in units comprising a first and a second flash memory bank, and the node further comprises a separate traffic and control system, characterized in the step of upgrading one of the memory banks and operating the other memory bank, where the process of upgrading and operation is mutually interchangeable between the memory banks, establishing redundant traffic buses and separating traffic and control system on intra boards and inter boards respectively.

25. A method according to claim 24, characterised in that hot swapping/removing/replacing a plug-in unit comprises the step of:
a. pushing or pulling a first switch indicating a plug-in unit removal,
b. wait for a first signal indicating an activation of the first switch,
c. when the first signal becomes active, denoting a start of a board removal interval time τ₂, and
d. removing the plug-in unit during the board removal interval time.

26. A method according to claim 25, characterised in that replacing said plug-in unit includes the step of removing said plug-in unit during the board removal interval τ₂ and within a second interval, a board replacement interval τ₆, adding a new plug-in unit to said telecommunication or data communication node.

27. A method according to claim 26, characterised in that if the board removal interval time, τ₂, expires without removal of a plug-in unit and the plug-in unit is an application plug-in unit, taking the plug-in unit will into service and performing an application plug-in warm restart.

28-29. (canceled)

30. A method according to claim 25, characterised in that a basic node software and an application node software interacts according to the following steps during removal/replacement/swapping of plug-in units:
a. pushing or pulling the first switch indicating a board removal causing the basic node software to inform the application node software that a plug-in unit shall be taken out of service,
b. the application node software executes a number of commands as a response to the information given from the basic node software,
c. thereafter, when the application node software has finished the number of commands it will report to the basic node software that the plug-in unit can be removed,
d. thereafter the basic node software is deallocating a peripheral component interconnect device drivers for the plug-in unit and indicates the deallocation with a visible signal, such as turning on a LED, and
e. the basic node software places the application plug-in unit in cold reset.

31. A method according to claim 24, characterised in installing temperature sensors in a serial peripheral interface building block for temperature supervision within said telecommunication or data communication node and measuring a temperature on all boards within said telecommunication or data communication node supporting two levels of temperature alarms.

32. A method according to claim 31, characterised in the step of separating the two levels of temperature alarms, into a first alarm indicating high temperature, and a second alarm indicating excessive temperature.

33. A method according to claim 32, characterised in setting an operational status of a severity level of the temperature alarm on the plug-in units to a following levels according to crossed temperature thresholds:
a. setting severity to minor if the temperature is above the high temperature threshold and below the excessive temperature threshold, or
b. setting severity to critical if the temperature is above the excessive temperature threshold.

34. A method according to claim 32, characterised in that operation of the node or plug-in units for temperatures following a temperature cycle measured by said sensors, ranging from a normal temperature interval to an excessive temperature interval and back to the normal temperature interval comprises the steps of:
a. running the node or plug-in units in normal operation, when the temperature is below the high temperature threshold,
b. automatically switching of control functions, unfaltering the traffic functions, and sending an alarm to a OAM system when the temperature is in the high temperature interval and rising from the normal temperature interval, control functions are automatically switched off,
c. automatically shutting down both control and traffic related hardware, sending an alarm to the OAM, this situation equals a cold reset when the temperature is in the excessive area interval rising from the high temperature interval,
d. restarting said node without control functions running, status is sent to the OAM when the temperature is in the high temperature interval, falling from the excessive temperature interval, and
e. returning said node and/or plug-in unit to normal operation when the temperature is in the normal temperature interval falling from the high temperature interval.

35. A method according to claim 34, characterised in that step b further comprises the step of setting application plug-in units to power save modus which is equal to setting the plug-in unit to a warm reset.

36. A method according to claim 34, characterised in that step e further comprises the step of:
restricting the step of return to normal operation to incidents where the temperature is below the high temperature threshold for a period longer than said board removal interval τ₂.

37. A method according to claim 24, characterised in that supervising one or more cooling fans by monitoring fan status and signaling the fan status on a serial peripheral interface bus from a power filter unit.

38. A method according to claim 37, characterised in supervising individual fans and indicating a failure if one fan fails.

39. A method according to claim 24, characterised in that said telecommunication or data communication node is monitoring correct local power on one or more application plug-in units.

40. A method according to claim 39, characterised in indicating a power failure situation by a visual signal such as turning off a power LED or lamp.

41-43. (canceled)

44. A method according to claim 24, characterised in that setting the first and second memory bank in a passive and an active state/modus respectively where the states/modes are mutually interchangeable between the first and second memory bank.

45. A method according to claim 24, characterised in that software upgrading the telecommunication or data communication node from a first version n to a second version n+1 comprises the following steps:
a. downloading the second version n+1 to a passive memory bank, and
b. writing a pointer to the passive memory bank making the passive memory bank the active one and consequently making the previous active memory bank passive.

46. A method according to claim 44, characterised in that step a further comprises the step of executing a test-run on the second version n+1.

47. A method according to claim 24, characterised in configuring a software system release with three software modules includes the step of:
a. establishing a traffic node basic node software in a node processor software load module,
b. establishing an application node software in a node processor software load module, and
c. establishing an application device software, such as application plug-in units with a device processor.

48. A method according to claim 47, characterised in software upgrading said telecommunication or data communication node from one system software release version, n, to another system software release version n+1.

49. A method according to claim 24, characterised in that installation of said telecommunication or data communication node comprises at least the following major steps:
a. equipping an application module magazine with a number of plug-in units where at least one of them is a node processor unit,
b. turn on the power for said node,
c. press a board removal switch,
d. perform a configuration check of the node processor unit,
e. check if radio link configuration is necessary, if necessary then radio link frequencies have to be configured and/or antenna alignment have to be configured,
f. executing manual or automatic security and software upgrade set up
g. exit the installation modus, and
h. perform a save of the configuration and enter normal operation for said telecommunication or data communication node.

50. A method according to claim 49, characterised in that further at step d deleting the configuration and replace it with factory settings if configuration is present, if configuration is replaced a software upgrade have to be preformed.

51. A method according to claim 49, characterised in that the manual set up comprises the following actions
a. initiating a manual upgrading if a software upgrade is necessary and displaying the upgrade progress, and
b. displaying the inventory data to an operator.

52. A method according to claim 49, characterised in that the automatic set up comprises the following steps:
a. specifying a configuration file,
b. loading the configuration file and append,
c. performing an automatic upgrade if a software upgrade is necessary and displaying the upgrade progress,
d. displaying at least the inventory data to an operator.

53. (canceled)
